(19) United States
(12) Patent Application Publication
(10) Pub. No.: US 2025/0242346 A1
(43) Pub. Date: Jul. 31, 2025

(54) MODULAR MICROVALVES FOR MICROFLUIDIC DEVICES AND METHODS OF USING THE SAME

(71) Applicant: Redbud Labs, Inc., Research Triangle Park, NC (US)

(72) Inventors: Richard Chasen Spero, Research Triangle Park, NC (US); Brittany Mason, Research Triangle Park, NC (US); John Hayes, Research Triangle Park, NC (US)

(73) Assignee: Redbud Labs, Inc., Research Triangle Park, NC (US)

(21) Appl. No.: 18/281,160

(22) PCT Filed: Mar. 16, 2022
(86) PCT No.: PCT/US22/20525

§ 371 Date: Sep. 8, 2023

Related U.S. Application Data
(60) Provisional application No. 63/161,725, filed on Mar. 16, 2021.

(51) Int. Cl. B01L 3/00

(52) U.S. Cl. CPC B01L 3/502738; B01L 3/502707; B01L 2200/027; B01L 2200/028; B01L 2200/0689; B01L 2200/12; B01L 2300/123; B01L 2400/0655

(57) ABSTRACT

Modular microvalves for microfluidic devices and methods of using the same are disclosed. Further, a microfluidic system is provided that may include the presently disclosed modular microvalves installed in a microfluidic device. Further, the microfluidic system may include valve actuators in relation to the presently disclosed modular microvalves. Further, the presently disclosed modular microvalves may be manufactured separately and independently of the manufacturing process of any microfluidic device and/or system. Non-limiting examples of the presently-disclosed modular microvalves may include but are not limited to, modular pinch valves, modular rocker valves, modular slider valves, modular rotary valves, and the like.

### CROSS-REFERENCE TO RELATED APPLICATION

The present application claims the benefit of priority to U.S. Provisional Patent Application No. 63/161,725, filed on Mar. 16, 2021, the entire contents of which are incorporated herein by reference.

### STATEMENT REGARDING FEDERALLY-FUNDED RESEARCH

This invention was made with government support under SBIR Grant No. R44A1150263-02 (“A Modular Platform for Infectious Disease Surveillance at the Point-of-Need”) awarded by the National Institutes of Health of the Department of Health and Human Services. The U.S. government has certain rights in the invention.

### TECHNICAL FIELD OF THE INVENTION

The presently disclosed subject matter relates generally to methods of controlling flow within microfluidic devices and more particularly to modular microvalves for microfluidic devices and methods of using the same.

Microfluidics, which include control of fluid at the microscale and nanoscale, finds many applications. One area is in the processing of small amounts of biological fluids. Specifically, a biological fluid (e.g., blood, saliva) can be processed on a microfluidic chip in order to determine the fluid composition and/or to quantify the presence of certain biomarkers in the fluid. This can be used in many applications including medical (human or veterinary) diagnostics.

In microfluidics, microfluidic valves are widely used for allowing, restricting, and/or adjusting a fluid flow in a microfluidic channel. For example, with the help of fluid valves, most conventional systems are able to provide controlled flows of sample fluids into multiple sections or channels on a microfluidic device (or cartridge). Currently, microfluidic valves are integrated directly into a microfluidic device during the manufacturing process, which adds complexity and cost to the manufacturing process of microfluidic devices. Further, because the function of the microfluidic valve is a product of the device fabrication and assembly process, the microfluidic valve cannot be prototyped and tested independently and without building an entire microfluidic device. Accordingly, new approaches are needed with respect to providing microfluidic valves with known function in a manner that is independent of the microfluidic device fabrication and assembly processes.

### SUMMARY OF THE INVENTION

The present invention provides a modular microvalve for use in a microfluidic device. In one embodiment, the modular microvalve may comprise (a) a valve supporter comprising: (i) a cylindrical non-compressible valve body having an inner surface, an outer surface, a top surface, a bottom surface, and an inner chamber; (ii) at least one integrated snap-arm coupled to the valve body and configured to couple the valve to a receptacle; and (b) a valve actuator seated within the valve supporter and comprising a compressible flex component comprising a pin.

In another embodiment, the bottom surface of the valve supporter may be in a sealable relationship with a corresponding top surface of the valve actuator.

In yet another embodiment, the valve actuator may be actuatable between a compressed and a non-compressed state.

In still another embodiment, each snap-arm may extend outwards from a side of the top outer surface of the valve supporter.

In another embodiment, each snap-arm may comprise a shoulder feature, an outer flat component extending downwards from the shoulder feature, and a latch-end at a proximal end of the outer flat component.

In yet another embodiment, the pin may be frustoconical in shape.

In still another embodiment, the pin may be a tapered cylinder.

In another embodiment, the pin may further comprise a divot feature on a proximal end of the pin, wherein the divot feature may comprise an actuatable flow space configured to either block fluid flow when compressed or to allow fluid flow when uncompressed.

The invention provides an assembly comprising a modular microvalve coupled to a microfluidic device.

In one embodiment, the microfluidic device of the assembly may comprise (i) one or more valve receptacles protruding upward from a top surface of the microfluidic device and arranged to allow the modular microvalves to engagedly connect to the valve receptacles via the snap-arms; (ii) latch features corresponding to the snap-arms arranged for engaging the snap-arms and thereby sealing the modular microvalve into the valve receptacle; (iii) one or more fluid openings in fluid contact with corresponding fluid channels arranged to allow for fluid communication between the modular microvalves and the fluid openings; and (iv) one or more fluid input loading wells in fluid communication with the fluid channels.

In another embodiment, the latch features may further comprise lip-edges in corresponding openings in the valve receptacles to engagedly connect to latch-ends.

In yet another embodiment, the modular microvalve may be arranged such that compression of the valve actuator prevents liquid flow from the fluid input loading well into the corresponding fluid opening.

In still another embodiment, the assembly may comprise an array of modular microvalves and corresponding valve receptacles.

In another embodiment, the array of modular microvalves and corresponding valve receptacles may be configured in a series.

In yet another embodiment, the array of modular microvalves and corresponding valve receptacles may be configured in parallel.

In still another embodiment, the array of modular microvalves and corresponding valve receptacles may be configured (both) in a series and in parallel.

In another embodiment, the array may comprise at least one (1) modular microvalve and a corresponding valve receptacle.

In yet another embodiment, the array may comprise up to at least eight (8) modular microvalves and corresponding valve receptacles.

In still another embodiment, the array may comprise between one (1) and thirty-six (36) (or more) modular microvalves and corresponding valve receptacles.

In another embodiment, the microfluidic device may further comprise an actuation means for applying a compression force to the modular microvalve.

In yet another embodiment, the actuation means for applying a compression force may be selected from a group consisting of a solenoid and piston mechanism, a pneumatic mechanism, or other suitable means for applying a compression force to actuate the pin component of the modular microvalve.

In other embodiments, the modular microvalves in fluid communication with the fluid channels may be actuatable between a closed configuration that inhibits fluid flow through the fluid openings into the fluid channels when the pin may be in a compressed state and an open configuration allowing fluid flow from the fluid input loading wells through the fluid openings into the fluid channels when the pin may be in an uncompressed state.

In another embodiment, the valve supporter may comprise a thermoplastic material.

In still another embodiment, the thermoplastic material may be selected from a group consisting of polycarbonate (PC), acrylonitrile butadiene styrene (ABS), or any other suitable rigid thermoplastic material.

In yet another embodiment, the valve actuator may comprise an elastomeric material.

In another embodiment, the elastomeric material may be selected from a group consisting of silicone, hydrogel, PDMS, TPE material, or any other suitable elastomeric material.

In still other embodiments, the diameter of the modular microvalve may be from about 8 mm to about 15 mm.

In still other embodiments, the snap-arms may extend outward from the valve supporter from about 1 mm to about 2 mm.

In still other embodiments, the height of the modular microvalve may be from about 3.6 mm to about 7.6 mm but is preferably 5.6 mm (+/−1 mm).

The present invention provides a method of forming a modular microvalve for use in a microfluidic device.

In one embodiment, the method may comprise the steps of (i) injection molding the valve supporter of any of the preceding claims; and (ii) injection molding the valve actuator of any of the preceding claims onto the surface of the valve supporter.

The present invention provides another method of forming a modular microvalve for use in a microfluidic device.

In one embodiment, the method may comprise the steps of (i) injection molding a separate valve supporter of any of the preceding claims; (ii) injection molding a separate valve actuator of any of the preceding claims; and (iii) adhering the separate valve supporter and the separate valve actuator together to form a single modular microvalve.

In another embodiment, the valve supporters and the valve actuators may be produced by 3D printing.

In still other embodiments, the modular microvalves may be formed according to a method selected from a group consisting of injection molding and 3D printing.

The present invention provides another modular microvalve for use in a microfluidic device.

In one embodiment, the modular microvalve may comprise (a) a valve supporter comprising (i) a cylindrical non-compressible valve body having an inner surface, an outer surface, a top surface, a bottom surface, and an inner chamber; and (ii) at least two integrated snap-arms coupled to the valve body and configured to couple the valve to a receptacle; and (b) a valve actuator seated within the valve supporter and comprising a compressible flex component comprising (i) a pin; and (ii) an optional bulge feature on a proximal end of the pin.

In yet another embodiment, the bottom surface of the valve supporter may be in a sealable relationship with a corresponding top surface of the valve actuator.

In still another embodiment, the valve actuator may be actuatable between a compressed and a non-compressed state.

In another embodiment, the bulge feature may be configured to block fluid flow when in a compressed state and allow fluid flow when in an uncompressed state.

In yet another embodiment, a bottom surface of the compressible flex component may be substantially flat and may be configured to block fluid flow when in a compressed state and allow fluid flow when in an uncompressed state.

The present invention provides a method of forming a modular microvalve that may contain a bulge feature for use in a microfluidic device.

In one embodiment, the method described in [0047] may comprise the steps of (i) injection molding the valve supporter; and (ii) injection molding the valve actuator onto the surface of the valve supporter.

The present invention provides another method of forming a modular microvalve that may contain a bulge feature for use in a microfluidic device.

In one embodiment, the method described in [0049] may comprise the steps of (i) injection molding a separate valve supporter; (ii) injection molding a separate valve actuator; and (iii) adhering (or sealing) the separate valve supporter and the separate valve actuator together to form a single modular microvalve.

In other embodiments, the valve supporters and the valve actuators may be produced by 3D printing.

The present invention provides a modular microvalve for use in a microfluidic device that may be formed according to a method selected from a group consisting of injection molding and 3D printing.

In another embodiment, the pin may further comprise a dimple feature on a distal end of the pin, wherein the dimple feature may be configured to increase and more evenly distribute compression force when the compression force may be applied to the pin.

In some embodiments, the valve actuator may comprise a partially-compressible flex component comprising a rigid dimple feature contained in a compressible flex structure and wherein the valve actuator may be configured to block fluid flow when a compression force is applied to the rigid dimple feature and allow fluid flow when in an uncompressed state.

In another embodiment, the rigid dimple feature may be located at or near the center of the compressible flex structure.

In other embodiments, the valve actuator in a modular microvalve containing a bulge feature may comprise a partially-compressible flex component comprising a rigid dimple feature contained in a compressible flex structure and wherein the valve actuator may be configured to block fluid flow when a compression force is applied to the rigid dimple feature and allow fluid flow when in an uncompressed state.

In another embodiment, the rigid dimple feature in a modular microvalve containing a bulge feature may be located at or near the center of the compressible flex structure.

In certain embodiments, the inner chamber of the valve supporter is formed between an inner surface of the valve body and an outer surface of the pin.

This application discloses non-limiting examples of various configurations of modular microvalves for use in a microfluidic device, e.g., modular pinch valves, adhesive-based modular pinch valves, modular pinch valves having a snap-fit design, snap-fit modular pinch valves including certain coupling features, snap-fit modular pinch valves including an alignment feature, modular pinch valves that may be oval-shaped rather than circular, spring-loaded modular microvalves, two-position modular rocket valves, three-position modular rocket valves, modular slider valves, single-channel modular rotary valves, multi-channel modular rotary valves, puck-based modular pinch valves, modular microvalves based on electrical switch configurations, SMA-based modular pinch valves, and modular pinch valves having a rivet weld design.

This application discloses various configurations of modular microfluidic valves that may be fabricated separately and then installed in a microfluidic device.

Other compositions, methods, features, and advantages of the invention will be or will become apparent to one with skill in the art upon examination of the following figures and detailed description.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1 and FIG. 2 illustrate schematic diagrams of a non-limiting example of the presently disclosed modular microvalves for use in microfluidic systems and/or devices;

FIG. 3 shows a photo of a non-limiting example of a microfluidic device including the presently disclosed modular microvalves;

FIG. 4A and FIG. 4B illustrate cross-sectional views of a non-limiting example of a basic configuration of a modular pinch valve, which is one non-limiting example of the presently disclosed modular microvalves;

FIG. 5A and FIG. 5B illustrate various views of a non-limiting example of a modular pinch valve including adhesive layers;

FIG. 6 and FIG. 7 illustrate exploded views of a non-limiting example of the adhesive-based modular pinch valve shown in FIG. 5 in relation to a microfluidic device and a valve actuator;

FIG. 8A illustrates a perspective view of a non-limiting example of a modular pinch valve having a snap-fit design and shown snap-fitted into a microfluidic device;

FIG. 8B illustrates a side view of the modular pinch valve shown in FIG. 8A and shown not yet snap-fitted into the microfluidic device;

FIG. 8C illustrates a plan view of a non-limiting example of a microfluidic device including an arrangement of multiple modular pinch valves shown in FIG. 8A;

FIG. 9 illustrates a cross-sectional view of a non-limiting example of the modular pinch valve having a snap-fit design shown in FIG. 8A;

FIG. 10 illustrates a side view and an exploded view of a non-limiting example of a snap-fit modular pinch valve including certain coupling features instead of adhesives;

FIG. 11 illustrates a side view and an exploded view of another non-limiting example of a snap-fit modular pinch valve including certain coupling features instead of adhesives;

FIG. 12 illustrates plan views of a non-limiting example of the snap-fit modular pinch valves shown in FIG. 8A through FIG. 11 and wherein the full circular area under its flexible membrane is flooded when the valve is open;

FIG. 13 illustrates plan views of a non-limiting example of the snap-fit modular pinch valves shown in FIG. 8A through FIG. 11 and wherein only a narrow channel area under its flexible membrane is flooded when the valve is open;

FIG. 14 illustrates plan views of a non-limiting example of the snap-fit modular pinch valves shown in FIG. 8A through FIG. 11 including a key feature for ensuring proper registration when installed;

FIG. 15 illustrates a cross-sectional view of a non-limiting example of the snap-fit modular pinch valves shown in FIG. 8A through FIG. 11 including an alignment feature on a lower surface for ensuring proper registration when installed;

FIG. 16 illustrates plan views of a non-limiting example of a modular pinch valve that may be oval-shaped rather than circular;

FIG. 17 illustrates plan views of a non-limiting example of a modular pinch valve wherein one fluid channel only is opened and closed;

FIG. 18 illustrates side views of a non-limiting example of a modular pinch valve including a snap-arm feature for snap-fitting and/or releasing the modular pinch valve;

FIG. 19 and FIG. 20 illustrate a perspective view and a side view, respectively, of a non-limiting example of a modular pinch valve having a snap-arm design;

FIG. 21A, FIG. 21B, and FIG. 21C illustrate cross-sectional views of the snap-arm modular pinch valve shown in FIG. 19 and FIG. 20;

FIG. 22 illustrates a side view of another non-limiting example of a modular pinch valve having a snap-arm design;

FIG. 23A and FIG. 23B illustrate cross-sectional views of the snap-arm modular pinch valve shown in FIG. 22;

FIG. 24 illustrates a perspective view of yet another non-limiting example of a modular pinch valve having a snap-arm design;

FIG. 25A and FIG. 25B illustrate cross-sectional views of the snap-arm modular pinch valve shown in FIG. 24;

FIG. 26 illustrates a perspective view of yet another non-limiting example of a modular pinch valve having a snap-arm design;

FIG. 27A and FIG. 27B illustrate cross-sectional views of the snap-arm modular pinch valve shown in FIG. 26;

FIG. 28 illustrates a perspective view, a side view, and a top view of still another non-limiting example of a modular microvalve (a “pinch” valve) having a snap-arm design;

FIG. 29A illustrates a perspective view and a detail view of a non-limiting example of a microfluidic device or cartridge including the snap-arm modular microvalve shown in FIG. 28;

FIG. 29B and FIG. 29C illustrate a top view and a bottom view, respectively, of the valve receptacle-portion of the microfluidic device shown in FIG. 29A absent the snap-arm modular microvalve shown in FIG. 28;

FIG. 30A, FIG. 30B, FIG. 31A, FIG. 31B, and FIG. 32 illustrate various cross-sectional views of the microfluidic device and snap-arm modular microvalve shown in FIG. 28;

FIG. 33 illustrates a perspective view of a non-limiting example of a microfluidic device or cartridge including multiple snap-arm modular microvalves shown in FIG. 28;

FIG. 34, FIG. 35, and FIG. 36 illustrate cross-sectional views of other non-limiting examples of the elastomeric valve actuation portion of the snap-arm modular microvalve shown in FIG. 28;

FIG. 37A and FIG. 37B illustrate perspective views of still another non-limiting example of a snap-arm modular microvalve and shown installed in a valve receptacle including features that help index and align the snap-arm modular microvalve to the microfluidic device;

FIG. 38A and FIG. 38B illustrate perspective views of the snap-arm modular microvalve shown in FIG. 37A and FIG. 37B;

FIG. 39 illustrates a plan view of a portion of a non-limiting example of a microfluidic device or cartridge including multiple snap-arm modular microvalves and valve receptacles shown in FIG. 37A and FIG. 37B;

FIG. 40 and FIG. 41 illustrate a perspective view and a plan view, respectively, of a portion of the microfluidic device or cartridge shown in FIG. 30 including one snap-arm modular microvalve and valve receptacle shown in FIG. 37A and FIG. 37B;

FIG. 42 illustrates side views of non-limiting examples of a modular microvalve secured to a microfluidic device via threaded elements;

FIG. 43 and FIG. 44 illustrate side views of non-limiting examples of a modular microvalve secured to a microfluidic device via clamping elements;

FIG. 45 illustrates side views of a non-limiting example of a normally-closed spring-loaded modular microvalve and a method of actuation;

FIG. 46A and FIG. 46B illustrate side views of a non-limiting example of a two-position modular rocker valve;

FIG. 47A, FIG. 47B, and FIG. 47C illustrate side views of a non-limiting example of a three-position modular rocker valve;

FIG. 48 illustrates side views of a non-limiting example of a modular slider valve and a process of using the modular slider valve;

FIG. 49 illustrates another non-limiting example of using the modular slider valve shown in FIG. 48;

FIG. 50 illustrates plan views of a non-limiting example of a single-channel modular rotary valve;

FIG. 51 illustrates plan views of a non-limiting example of a multi-channel modular rotary valve;

FIG. 52 illustrates side views of a non-limiting example of a puck-based modular pinch valve in which the valve actuator may be located away from the location of the valve itself;

FIG. 53 illustrates schematic views of modular microvalves that may be based on electrical switch configurations;

FIG. 54 through FIG. 58 illustrate side views of non-limiting examples of SMA-based modular pinch valves that may be actuated via the action of an SMA element;

FIG. 59 illustrates a perspective view of a non-limiting example of a modular pinch valve having a rivet weld design; and

FIG. 60A and FIG. 60B illustrate cross-sectional views of a non-limiting example of a process of forming the rivet of the modular pinch valve shown in FIG. 59.

### DETAILED DESCRIPTION OF THE INVENTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides modular microvalves for microfluidic devices and methods of using them. For example, a microfluidic system (or assembly) is provided that may include the presently disclosed modular microvalves installed in a microfluidic device (e.g., digital microfluidics (DMF) cartridge). Further, the microfluidic system may include valve actuators in relation to the presently disclosed modular microvalves. Further, the presently disclosed modular microvalves may be manufactured separately and independently of the manufacturing process of any microfluidic device and/or system.

In some embodiments, the presently disclosed modular microvalves for microfluidic devices and methods provide modular microvalves that are in the “normally-open” or “default-open” state.

In some embodiments, the presently disclosed modular microvalves for microfluidic devices and methods provide modular microvalves that are in the “normally-closed” or “default-closed” state.

In some embodiments, the presently disclosed modular microvalves for microfluidic devices may be fitted into corresponding valve receptacles of a microfluidic device and wherein each of the valve receptacles is provided in relation to one or more fluid channels of the microfluidic device.

In some embodiments, the presently disclosed modular microvalves for microfluidic devices and methods provide modular single-pole pinch valves and a process of operating the modular pinch valves using valve actuators.

In some embodiments, the presently disclosed modular microvalves for microfluidic devices and methods provide modular single-pole pinch valves that may be fitted into valve receptacles and held via adhesives.

In some embodiments, the presently disclosed modular microvalves for microfluidic devices and methods provide modular single-pole pinch valves that may be snap-fitted into valve receptacles in the absence of adhesives.

In some embodiments, the presently disclosed modular microvalves for microfluidic devices and methods provide modular single-pole pinch valves that may be snap-fitted into valve receptacles using snap-arms.

In some embodiments, the presently disclosed modular microvalves for microfluidic devices and methods provide modular single-pole pinch valves that may be snap-fitted into valve receptacles using snap-arms protruding from the valve receptacles for engaging and holding the modular single-pole pinch valves.

In some embodiments, the presently disclosed modular microvalves for microfluidic devices and methods provide modular single-pole pinch valves that may be snap-fitted into valve receptacles using snap-arms protruding from the modular single-pole pinch valves for engaging the valve receptacles and being held therein.

In some embodiments, the presently disclosed modular microvalves for microfluidic devices and methods provide modular single-pole pinch valves in which a flexible membrane may be secured to a rigid valve body using certain mechanical coupling features in the absence of adhesives.

In some embodiments, the presently disclosed modular microvalves for microfluidic devices and methods provide modular single-pole pinch valves including certain alignment features for ensuring proper registration to the receiving microfluidic device.

In some embodiments, the presently disclosed modular microvalves for microfluidic devices and methods provide modular single-pole pinch valves of various shapes, such as but not limited to, circular-shaped, ovular-shaped, rectangular-shaped, and the like.

In some embodiments, the presently disclosed modular microvalves for microfluidic devices and methods provide modular single-pole pinch valves that may be held onto the receiving microfluidic device via threaded elements, such as, but not limited to, screws and threaded studs and nuts.

In some embodiments, the presently disclosed modular microvalves for microfluidic devices and methods provide modular single-pole pinch valves that may be held onto the receiving microfluidic device via shell types of clamps fitted over the valve body and then secured to the microfluidic device.

In some embodiments, the presently disclosed modular microvalves for microfluidic devices and methods provide modular rocker valves and a process of using the modular rocker valves.

In some embodiments, the presently disclosed modular microvalves for microfluidic devices and methods provide modular slider valves and a process of using the modular slider valves.

In some embodiments, the presently disclosed modular microvalves for microfluidic devices and methods provide modular rotary valves and a process of using the modular rotary valves.

In some embodiments, the presently disclosed modular microvalves for microfluidic devices and methods provide a puck-based modular pinch valve and a process of using the puck-based modular pinch valve.

In some embodiments, the presently disclosed modular microvalves for microfluidic devices and methods provide shape-memory alloy (SMA)-based modular pinch valves that may be actuated via the action of an SMA element.

### Modular Microvalves

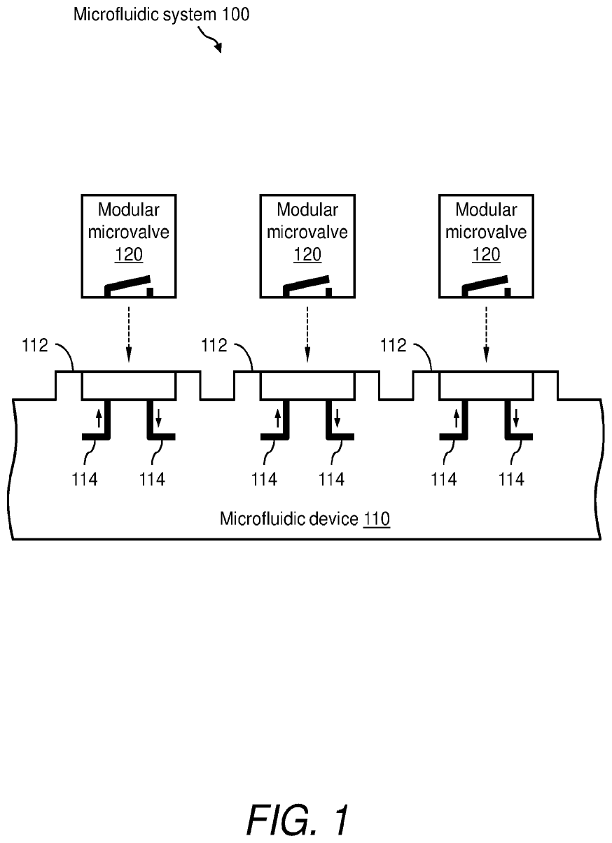

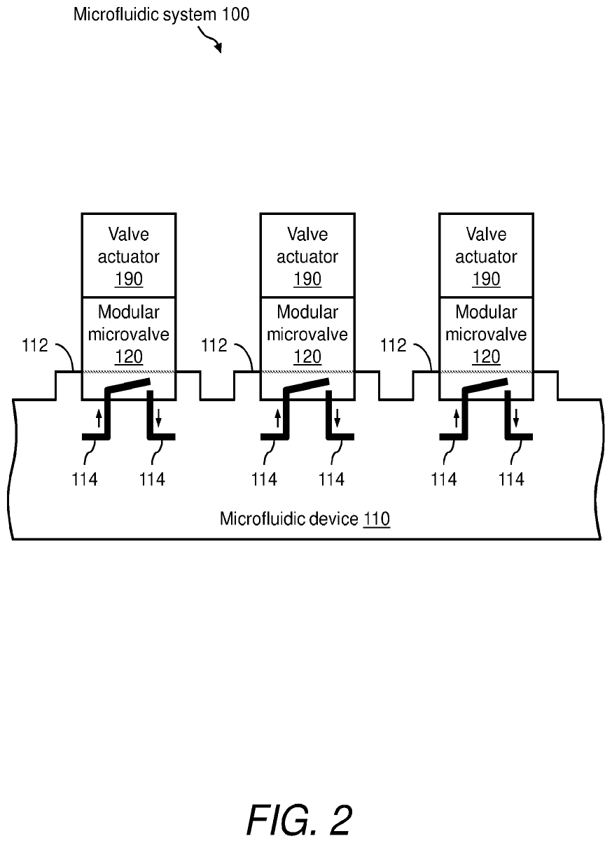

Referring now to FIG. 1 and FIG. 2 are schematic diagrams of a non-limiting example of the presently disclosed modular microvalves for use in microfluidic systems and/or devices. For example, FIG. 1 and FIG. 2 show a microfluidic system 100 that may include a microfluidic device 110, such as a DMF cartridge. Microfluidic device 110 may include an arrangement of one or more valve receptacles 112 for receiving one or more of the presently disclosed modular microvalves 120. Further, microfluidic device 110 may include any arrangement of fluid channels 114. For example, each modular microvalve 120 may be fluidly connected to at least one input fluid channel 114 and to at least one output fluid channel 114. Further, an actuating device may be associated with each of the modular microvalves 120. By way of non-limiting example, FIG. 2 shows a valve actuator 190 that corresponds to each modular microvalve 120.

In microfluidic system 100, the one or more modular microvalves 120 may be manufactured separately and independently of the manufacturing process of any microfluidic device, such as microfluidic device 110. Valve receptacles 112 of microfluidic device 110 may be tailored to receive any type of modular microvalve 120.

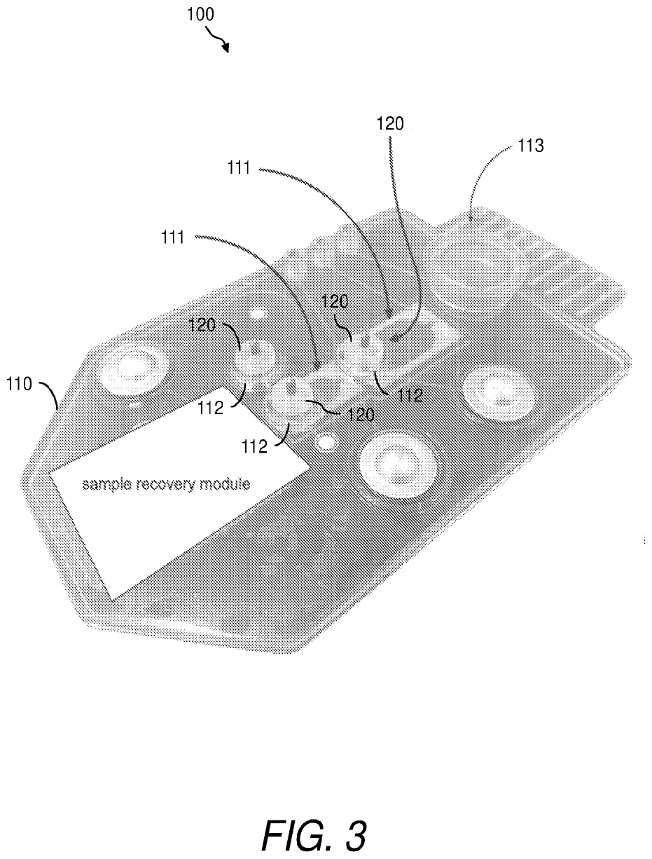

In microfluidic system 100, each modular microvalve 120 may be provided to control the flow of fluid in, for example, a certain fluid channel 114 in microfluidic device 110. For example, each modular microvalve 120 may be provided to allow flow, block flow, and/or meter flow in a fluid path, channel, or line. In some embodiments, each modular microvalve 120 may include a flexible membrane that may be driven up and down for opening and closing the valve. Accordingly, in some embodiments, valve actuator 190 may be, for example, a solenoid and piston mechanism or pneumatic mechanism that can be used to drive the flexible membrane up or down. More details of non-limiting examples of the presently disclosed modular microvalves 120 are shown and described hereinbelow with reference to FIG. 3 through FIG. 60.

Referring now to FIG. 3 is a photo of a non-limiting example of a microfluidic device 110 including the presently disclosed modular microvalves 120 installed in valve receptacles 112. The valve receptacles 112 holding the modular microvalves 120 may be arranged, for example, with respect to certain reaction or assay chambers 111 and fluid reservoirs 113.

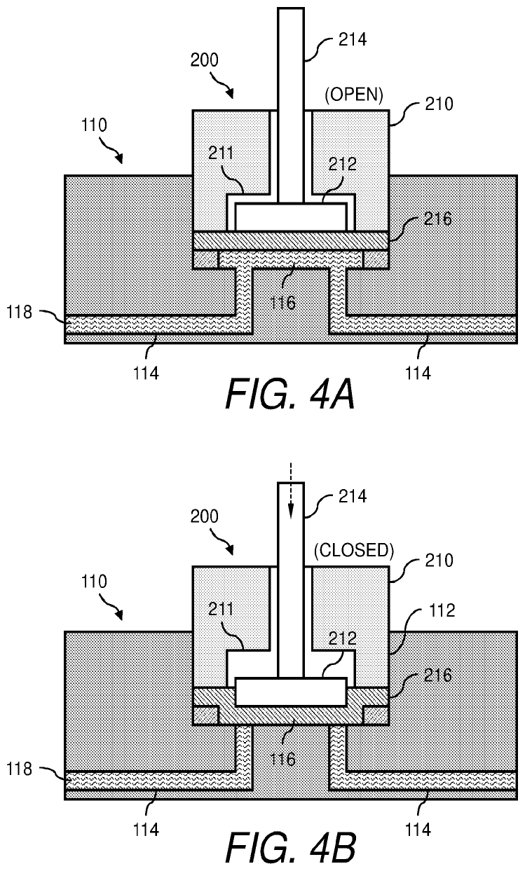

Referring now to FIG. 4A and FIG. 4B is cross-sectional views of a non-limiting example of a basic configuration of a modular pinch valve 200, which is one non-limiting example of the presently disclosed modular microvalves 120 shown in FIG. 1 and FIG. 2. modular pinch valve 200 may include a valve body 210 having a cavity 211 therein for housing a valve plunger 212. Further, a valve actuation pin 214 is connected to valve plunger 212 and protrudes outward through an opening in the valve body 210. Generally, the valve body 210 may have a cylindrical shape for holding valve plunger 212 and valve actuation pin 214.

Further, a flexible membrane 216 spans the end of the valve body 210 opposite valve actuation pin 214. Flexible membrane 216 may be formed of an elastomeric (flexible) material, such as, but not limited to, silicone, hydrogel, polydimethylsiloxane (PDMS), thermoplastic elastomer (TPE) material, and the like. In one non-limiting example, the elastomeric material may have a durometer rating of about 40A and may be about 500 μm thick. Further, it is beneficial that the elastomeric material used to form flexible membrane 216 be (1) compatible with ethanol and surfactants, and (2) mechanically stable at temperatures up to about 95° C.

Flexible membrane 216 may be from about 200 μm to about 1500 μm thick in one non-limiting example, or about 500 μm thick in another non-limiting example. Using valve plunger 212 and valve actuation pin 214, a valve actuator 190 (not shown) may be used to drive flexible membrane 216 up or down. For example, a “neutral” position may be the flexible membrane 216 substantially flat across the open end of valve body 210, as shown in FIG. 4A. A “positive” position may be the flexible membrane 216 pushed or deflected outwardly from the open end of valve body 210, as shown in FIG. 4B. A “negative” position (not shown) may be the flexible membrane 216 pulled or deflected inwardly into cavity 211 of valve body 210.

FIG. 4A and FIG. 4B shows modular pinch valve 200 arranged with respect to microfluidic device 110 and more particularly with respect to two fluid channels 114 of microfluidic device 110. Referring now to FIG. 4A, modular pinch valve 200 is in the open state. For example, flexible membrane 216 is in the “neutral” position allowing a space 116 between flexible membrane 216 and microfluidic device 110. Space 116 provides the fluid path between the two fluid channels 114.

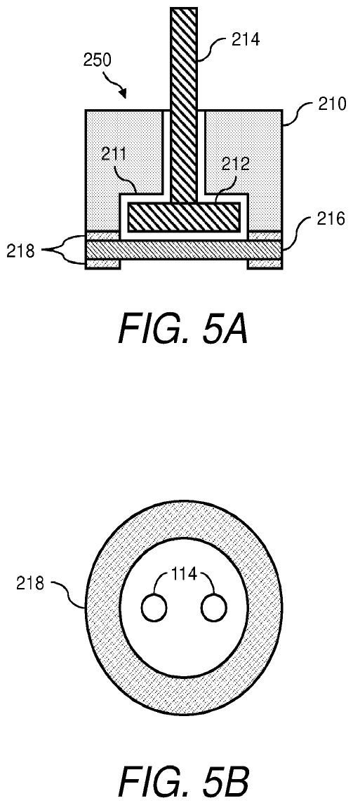

Referring now to FIG. 4B, modular pinch valve 200 is in a closed state. For example, using valve plunger 212 (driven by valve actuator 190), flexible membrane 216 may be deflected into the “positive” position, which causes the deflected flexible membrane 216 to fill space 116 and block the flow of fluid 118 between the two fluid channels 114. In one non-limiting example, up to about ten (10) PSI of pressure may exist on the fluid channel-side of flexible membrane 216. In this non-limiting example, about four (4) Newtons (N) of downward force may be applied to valve plunger 212 to overcome the ten (10) PSI of pressure and deflect flexible membrane 216 and close modular pinch valve 200. Specific non-limiting examples of modular pinch valves that may be based on the basic configuration of modular pinch valve 200 are shown and described hereinbelow with reference to FIG. 5 through FIG. 45.

Referring now to FIG. 5A is a cross-sectional view of a non-limiting example of a modular pinch valve 250 including adhesive layers. The adhesive-based modular pinch valve 250 is another non-limiting example of the presently disclosed modular microvalves 120 shown in FIG. 1 and FIG. 2. In this non-limiting example, modular pinch valve 250 may include valve body 210 with cavity 211 that houses valve plunger 212 and valve actuation pin 214. Further, flexible membrane 216 spans valve body 210. In this non-limiting example, flexible membrane 216 is secured to valve body 210 via a first adhesive layer 218. Further, a second adhesive layer 218 is provided on the outside of flexible membrane 216 for securing modular pinch valve 250 into a valve receptacle 112 of microfluidic device 110 (not shown). FIG. 5B shows a plan view of adhesive layers 218 in relation to two (2) fluid channels 114. For example, adhesive layers 218 may be doughnut-shaped layers wherein the opening provides clearance for valve plunger 212 to interact with flexible membrane 216.

Valve body 210 may be a cylindrical-shaped body formed, for example, of machined polycarbonate, molded plastic, and the like. In one non-limiting example, valve body 210 may have an outside diameter (OD) of about 7.3 mm and a height of about 3.1 mm.

In this non-limiting example, valve plunger 212 may be selected to be large enough to span the two fluid channels 114. For example, fluid channels 114 may be about 0.75 mm in diameter and spaced about 0.5 mm apart. In one non-limiting example, valve plunger 212 and valve actuation pin 214 may be the stainless-steel pin (e.g., P/N 95648A340) available from McMASTER-CARR®. In this non-limiting example, valve plunger 212 may be about 3.02 mm in diameter, valve actuation pin 214 may be about 2 mm in diameter, and together valve plunger 212 and valve actuation pin 214 may have an overall length of about 8 mm. In this non-limiting example, cavity 211 may have a diameter of about 3.1 mm to accommodate the 3 mm-valve plunger 212.

Again, flexible membrane 216 may be formed of an elastomeric (flexible) material, such as, but not limited to, silicone, hydrogel, PDMS, TPE material, and the like. In one non-limiting example, flexible membrane 216 may be formed of a silicone rubber sheet (e.g., P/N 86915K12) available from McMASTER-CARR®. In one non-limiting example, adhesive layers 218 may be acrylic pressure-sensitive adhesive (PSA) layers that may be, for example, about 142 μm thick. Further, the adhesive layer 218 that faces microfluidic device 110 may help form the space 116 shown in FIG. 4A.

### Snap-Fit Designs of Modular Pinch Valves

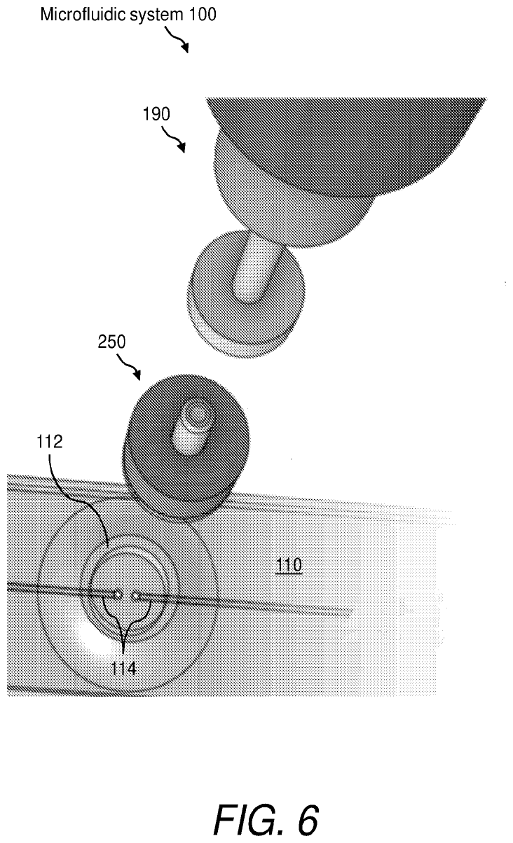

FIG. 6 through FIG. 17 show non-limiting examples of the presently disclosed modular microvalves 120 designed to snap-fit or press-fit into a microfluidic device, such as microfluidic device 110 of microfluidic system 100 shown in FIG. 1, FIG. 2, and FIG. 3.

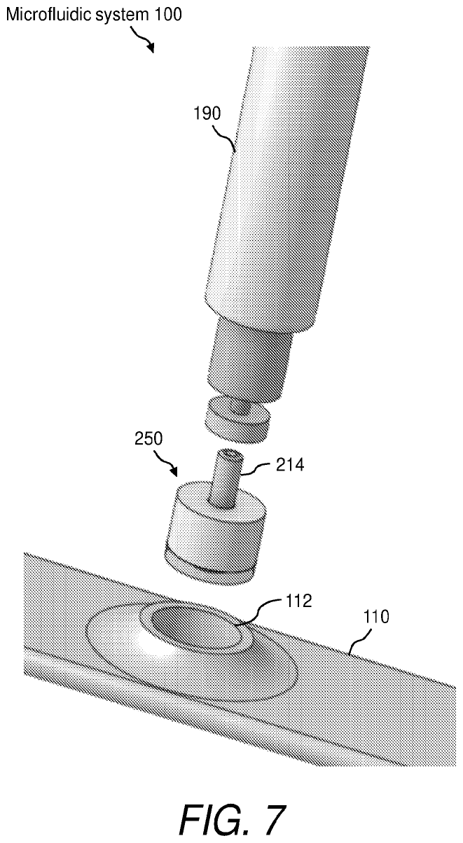

Referring now to FIG. 6 and FIG. 7 is exploded views of a non-limiting example of the adhesive-based modular pinch valve 250 shown in FIG. 5 in relation to a microfluidic device 110 and a valve actuator 190. For example, microfluidic device 110 has a valve receptacle 112 that substantially corresponds to the size and shape of modular pinch valve 250. Further, the tip of the valve actuator 190 substantially aligns with valve actuation pin 214 of modular pinch valve 250. Any of the presently disclose modular microvalves 120 described herein, such as modular pinch valve 250, may be designed to attach securely to the microfluidic device (or cartridge) 110 such that an airtight seal is formed.

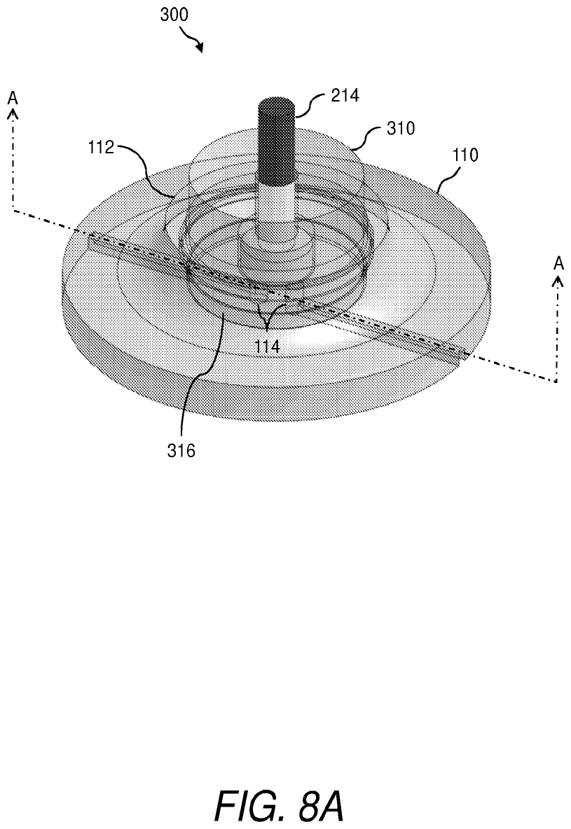

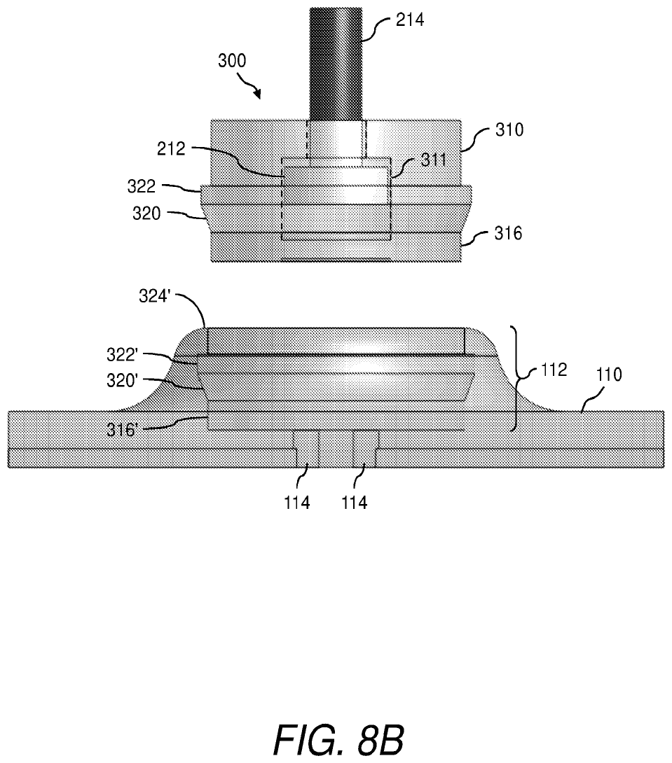

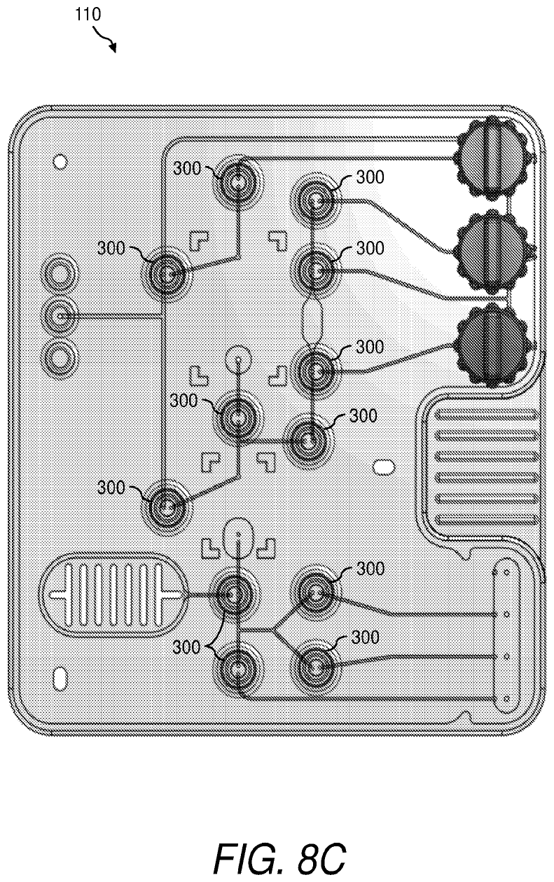

Referring now to FIG. 8A is a perspective view of a non-limiting example of a modular pinch valve 300 having a snap-fit design and shown snap-fitted into a microfluidic device 110. Further, FIG. 8B shows a side view of modular pinch valve 300 shown in FIG. 8A and shown not yet snap-fitted into microfluidic device 110. Further to the non-limiting example, FIG. 8C shows a plan view of a non-limiting example of microfluidic device 110 including an arrangement of multiple modular pinch valves 300 shown in FIG. 8A.

The snap-fit modular pinch valve 300 is another non-limiting example of the presently disclosed modular microvalves 120 shown in FIG. 1 and FIG. 2. In this non-limiting example, modular pinch valve 300 may include a valve body 310 with a cavity 311 that houses valve plunger 212 and valve actuation pin 214. Further, a flexible membrane 316 spans the open end of valve body 310. Flexible membrane 316 may be formed of an elastomeric (flexible) material, such as, but not limited to, silicone, hydrogel, PDMS, TPE material, and the like. In one non-limiting example, the elastomeric material may have a durometer rating of about 40A and may be about 500 μm thick. Further, it is beneficial that the elastomeric material used to form flexible membrane 316 be (1) compatible with ethanol and surfactants, and (2) mechanically stable at temperatures up to about 95° C.

In one non-limiting example, the stack of valve body 310 and flexible membrane 316 has an overall height of about 0.7 mm and an overall diameter of about 7.3 mm. In one non-limiting example, for a 3 mm-valve plunger 212, the diameter of cavity 311 may be about 3.1 mm. In one non-limiting example, valve actuation pin 214 may protrude about 2 mm above valve body 310 for easy actuation. Further, valve actuation pin 214 may have a minimum diameter of about 2.5 mm. In one non-limiting example, flexible membrane 316 may have a thickness of about less than 10 mm.

The snap-fit design of modular pinch valve 300 includes features formed around the outside portion of valve body 310 and corresponding features formed around the inside of valve receptacle 112 of microfluidic device 110. For example, valve body 310 includes a tapered leading edge 320, which is the edge facing flexible membrane 316. Tapered leading edge 320 is narrowest facing flexible membrane 316 and widens out toward a center portion of valve body 310. Accordingly, a ridge or lip 322 is formed at about the center portion of valve body 310.

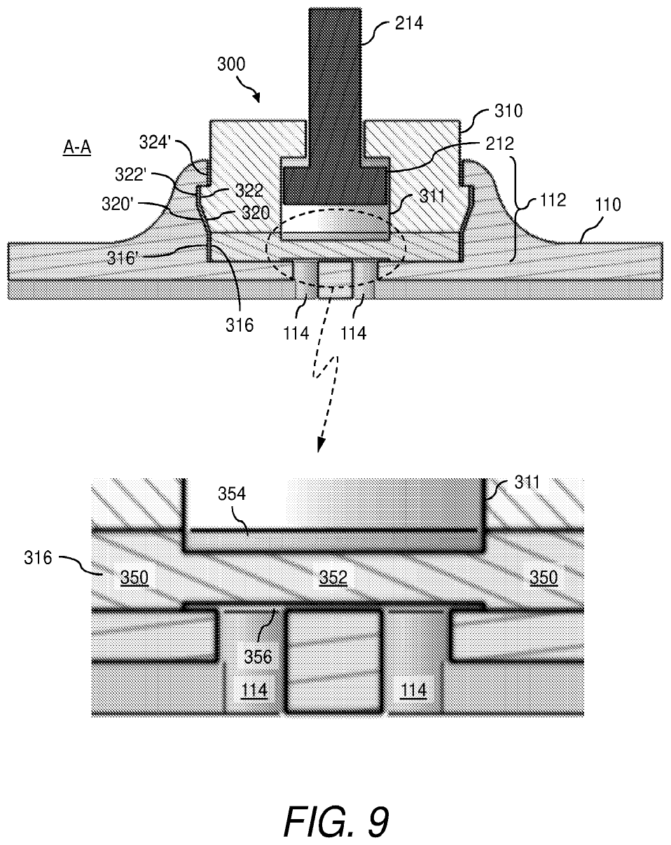

Referring now to FIG. 9 is a cross-sectional view of the modular pinch valve 300 taken along line A-A of FIG. 8A. As shown in FIG. 9, the inside of valve receptacle 112 of microfluidic device 110 may include a face 316′ for receiving flexible membrane 316, a face 320′ for receiving tapered leading edge 320 of valve body 310, and a face 322′ for receiving ridge or lip 322 of the valve body 310. Further, valve receptacle 112 may include a ridge or collar 324′ for latching against the upper face of the ridge or lip 322 of the valve body 310 when modular pinch valve 300 is snapped into valve receptacle 112.

Further, FIG. 9 shows more details of flexible membrane 316 of modular pinch valve 300. For example, flexible membrane 316 may include an outer gasket portion 350 and an inner valving portion 352. Outer gasket portion 350 provides a gasket function with respect to sealing modular pinch valve 300 within valve receptacle 112 of microfluidic device 110. Further, inner valving portion 352 is thinner than outer gasket portion 350 and provides the valving function of modular pinch valve 300. In one non-limiting example, outer gasket portion 350 of flexible membrane 316 may be about 150 μm thick, and inner valving portion 352 may be about 700 μm thick.

Because inner valving portion 352 is thinner than outer gasket portion 350, a space 354 is formed on the plunger-side of flexible membrane 316 that essentially extends cavity 311 of valve body 310 into flexible membrane 316. Further, when flexible membrane 316 is in the “neutral” position, a space 356 is formed on the fluid channel-side of flexible membrane 316. That is, when modular pinch valve 300 is open, space 356 provides the fluid path between the two fluid channels 114. By contrast, modular pinch valve 300 is closed by valve plunger 212 deflecting flexible membrane 316 into the “positive” position (see FIG. 4B). In so doing, space 356 may be blocked and, consequently, the flow of fluid between the two fluid channels 114 is blocked.

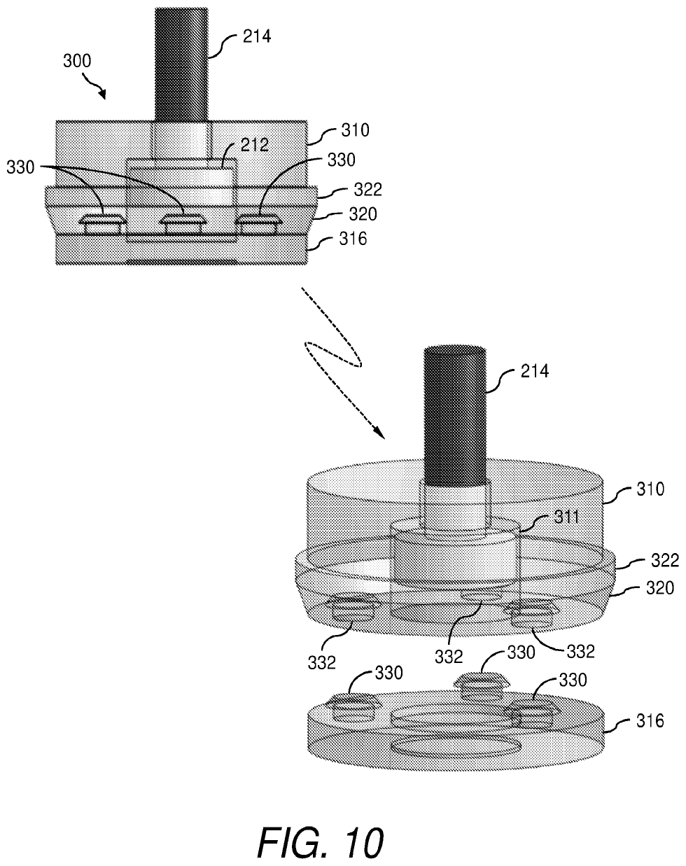

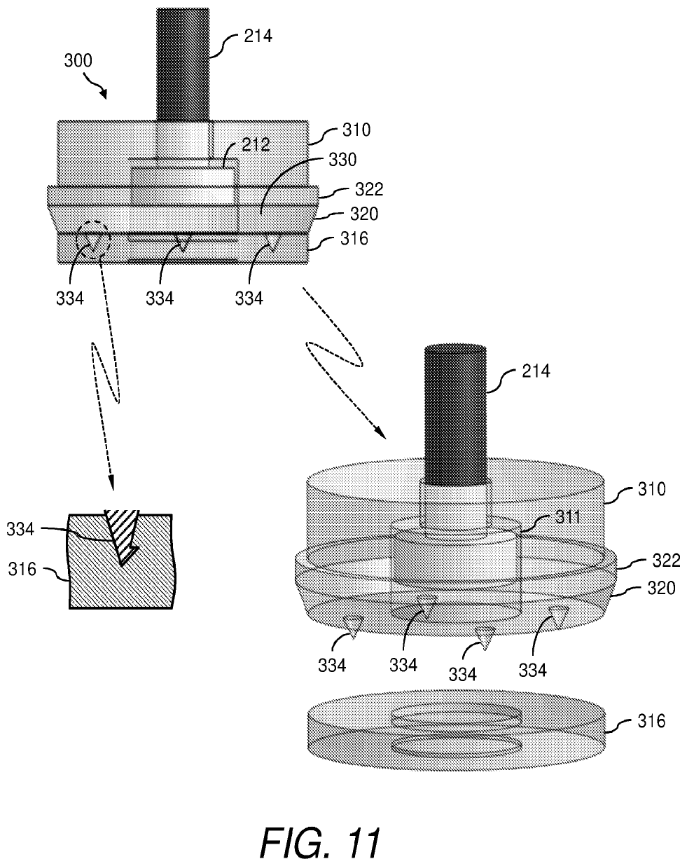

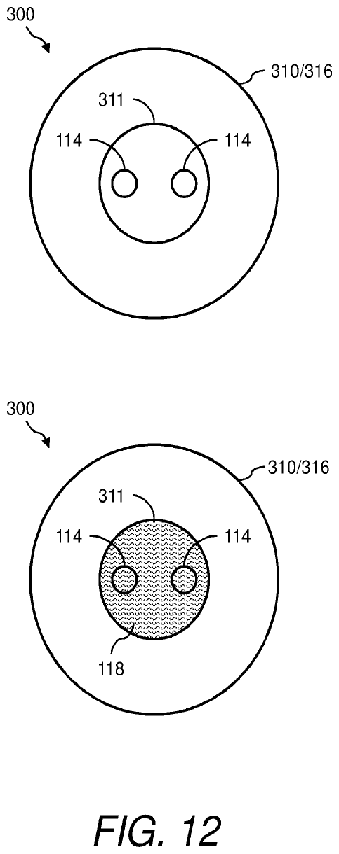

The snap-fit design of modular pinch valve 300 may provide some benefit over the adhesive-based modular pinch valve 250 shown in FIG. 5, FIG. 6, and FIG. 7 due to the absence of adhesives. For example, snap features are provided for holding modular pinch valve 300 into valve receptacle 112. Accordingly, no adhesive layer is needed on the underside of flexible membrane 316, simplifying assembly. Further, and referring now to FIG. 10, FIG. 11, and FIG. 12 certain mechanical coupling features may be provided between the valve body 310 and flexible membrane 316. Accordingly, no adhesive layer is needed to hold flexible membrane 316 to valve body 310, simplifying assembly.

Referring now to FIG. 10 is a side view and an exploded view of a non-limiting example of a snap-fit modular pinch valve 300 including certain mechanical coupling features instead of adhesives. In this non-limiting example, an arrangement of latching features 330 protrude from the surface of outer gasket portion 350 of flexible membrane 316 facing valve body 310. The latching features 330 may be, for example, top hat type features. Accordingly, an arrangement of the corresponding receiving features 332 is provided in the underside of valve body 310. In this non-limiting example, latching features 330 of flexible membrane 316 are designed to be snap-fitted into receiving features 332 of valve body 310. In this way, flexible membrane 316 may be affixed to valve body 310 without the need for adhesives. In another configuration, the latching features 330 are on valve body 310 and the receiving features 332 are in flexible membrane 316.

In the non-limiting example shown in FIG. 10, the latching features 330 may be, for example, top-hat type features. However, in another non-limiting example and referring now to FIG. 11, the latching features 330 of modular pinch valve 300 may be barbed-type features. In this non-limiting example, an arrangement of barbed features 334 protrudes from the underside of valve body 310. Simply, barbed features 334 may be pressed into the soft material (e.g., silicone rubber) of flexible membrane 316 wherein the barbed features 334 pierce the soft material and then “catch” into the soft material and hold. In this way, flexible membrane 316 may be affixed to valve body 310 without the need for adhesives.

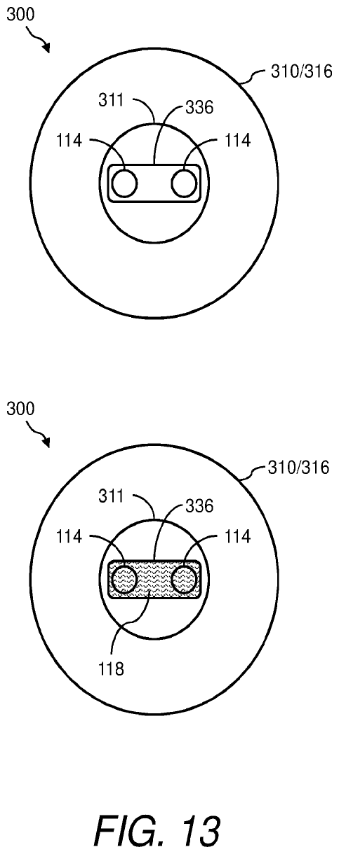

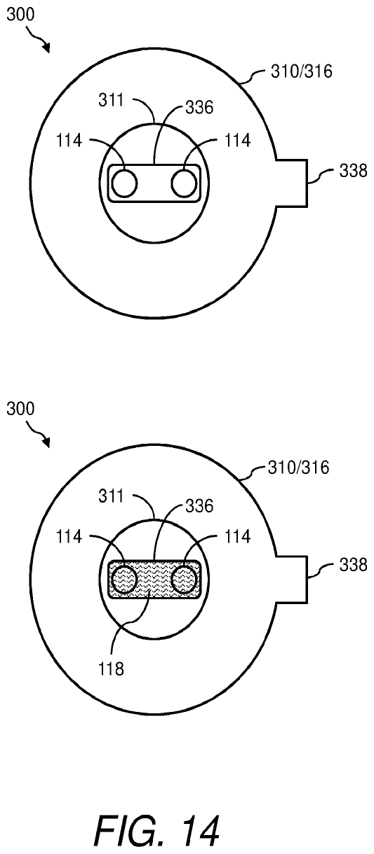

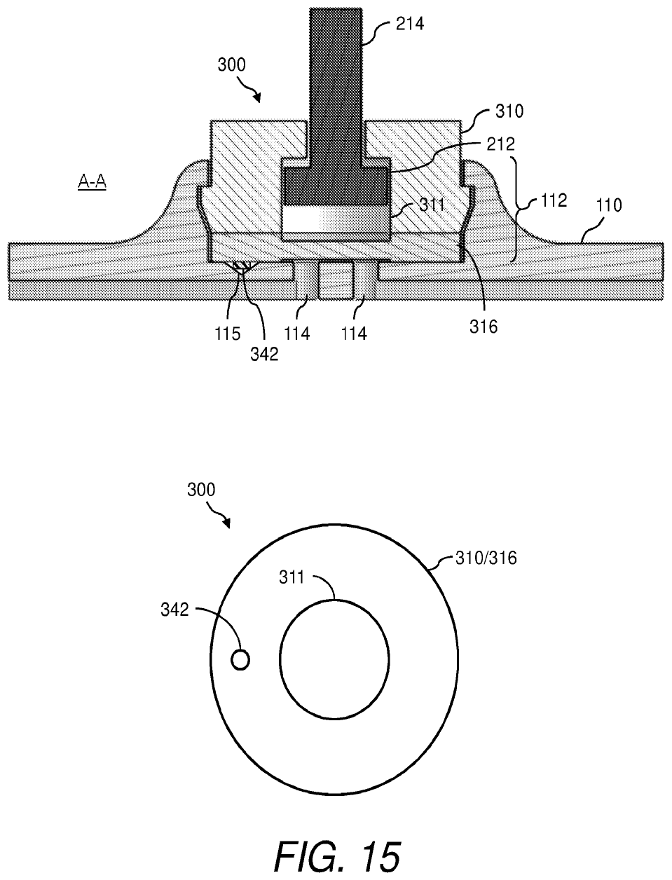

Referring now to FIG. 12 is plan views of a non-limiting example of the snap-fit modular pinch valves 300 shown in FIG. 8A through FIG. 11 and wherein the full circular area (e.g., space 356) under flexible membrane 316 may be flooded when the valve is open. However, there may be a reason to limit the volume of fluid in this space at modular pinch valve 300. Accordingly, FIG. 13 shows a narrow channel 336 is provided beneath flexible membrane 316 to limit and guide the flow when the valve is open. Further, it may be useful for modular pinch valve 300 to be installed with a certain orientation. Accordingly, FIG. 14 shows a non-limiting example of modular pinch valve 300 that includes at least one key feature 338 to ensure proper registration when installed in valve receptacle 112. In this non-limiting example, key feature 338 protrudes from the side of valve body 310. Key feature 338 may have any shape. Further, a corresponding receiving key feature (not shown) is provided in valve receptacle 112. In another non-limiting example, the registration or alignment feature may be located on the underside of valve body 310 rather than from the side of valve body 310. For example, FIG. 15 is a cross-sectional view showing an alignment feature 342 on a lower surface of the valve body 310 for ensuring proper registration when installed. In this non-limiting example, a groove 115 may be provided in valve receptacle 112 for receiving alignment feature 342. Again, alignment feature 342 and groove 115 may have any shape.

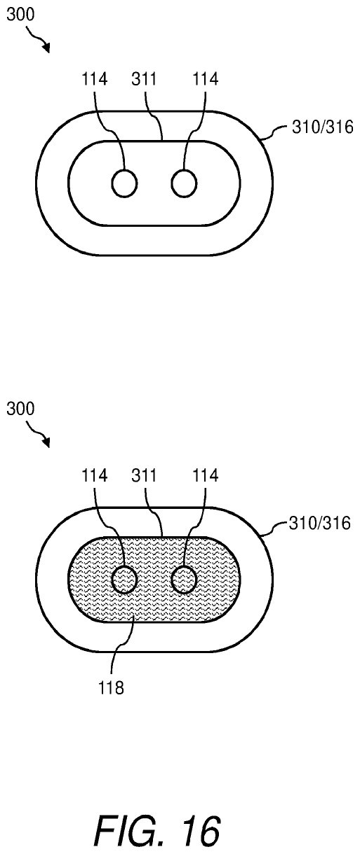

Further, valve body 310 of modular pinch valve 300 is not limited to circular. For example, FIG. 16 shows an oval-shaped valve body 310 (without and with fluid 118 present). Other shapes are also possible, such as rectangular. Further, any of the modular pinch valves 300 may include “twist-lock” style mechanisms (not shown), such as but not limited to, a “leur-lock” style, a “cam-lock” style, and the like, for assisting installation into valve receptacles 112.

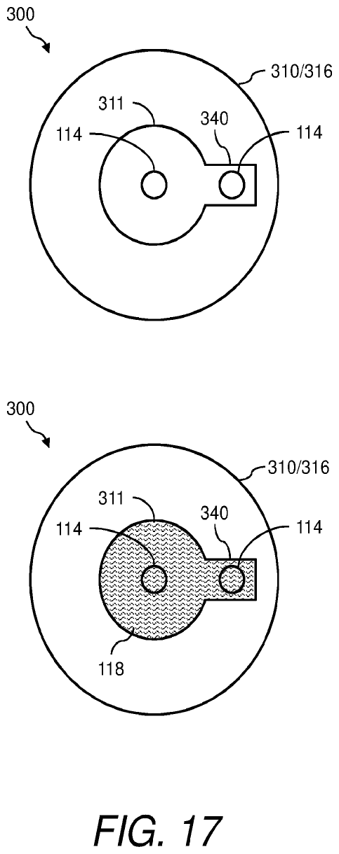

Referring now to FIG. 17 is plan views of a non-limiting example of a modular pinch valve 300 wherein one fluid channel only is opened and closed. This non-limiting example of modular pinch valve 300 is shown without and with fluid 118 present. In this non-limiting example, only one fluid channel 114 is located in the center region of the valve body 310 and flexible membrane 316. In this non-limiting example, the second fluid channel 114 is located in an elongated protrusion 340 that is provided at one side of valve body 310. In operation, when valve plunger 212 is actuated, only the one fluid channel located within the main valve body 310 is opened and closed by flexible membrane 316. In this non-limiting example, the main valve body 310, cavity 311, and valve plunger 212 may have smaller diameters. That is, overall, the modular pinch valve 300 (excluding elongated protrusion 340) may have a smaller diameter compared with a modular pinch valve 300 spanning two (2) fluid channels 114.

### Snap-Arm Designs of Modular Microvalves

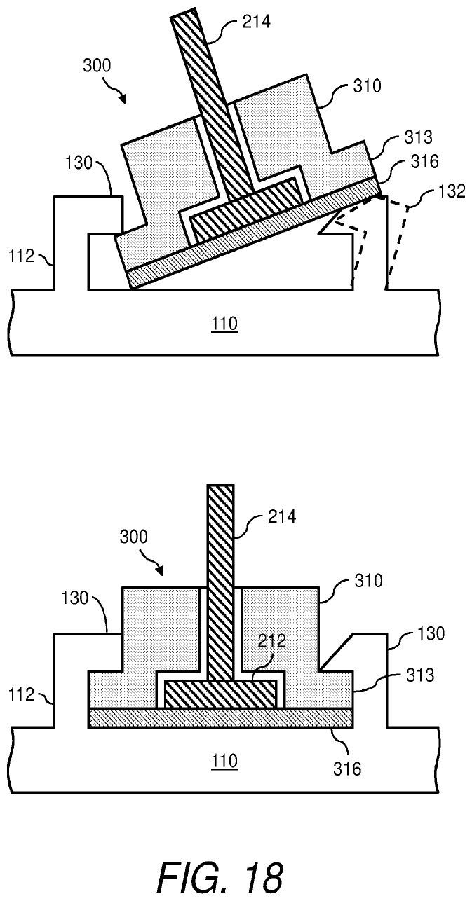

FIG. 18 through FIG. 41 show non-limiting examples of the presently disclosed modular microvalves 120 including snap-arm features for holding into a microfluidic device, such as microfluidic device 110 of microfluidics system 100 shown in FIG. 1, FIG. 2, and FIG. 3.

Referring now to FIG. 18 is side views of a non-limiting example of a modular pinch valve 300 including a snap-arm feature for snap-fitting and/or releasing modular pinch valve 300. FIG. 18 also shows a process of snap-fitting modular pinch valve 300 into a certain type of valve receptacle 112 of microfluidic device 110 that may allow valve receptacle 112 to be releasable. In this non-limiting example, modular pinch valve 300 may include a rim or ridge 313 around the flexible membrane 316-end of valve body 310. Rim or ridge 313 provides a step or shelf type of profile around the perimeter of valve body 310. Additionally, one portion of valve receptacle 112 includes an overhang feature 130, and another portion of valve receptacle 112 includes a snap-arm feature 132. In operation, modular pinch valve 300 is provided at an angle or tilt such that a portion of its rim or ridge 313 engages with overhang feature 130 of valve receptacle 112. Then, as modular pinch valve 300 is pushed further into valve receptacle 112, the remaining rim or ridge 313 slips past snap-arm feature 132 and drops fully into valve receptacle 112. Once installed, snap-arm feature 132 snaps shut atop rim or ridge 313 of modular pinch valve 300. In this non-limiting example, a user may pull back snap-arm feature 132 and release and remove modular pinch valve 300 from valve receptacle 112 of microfluidic device 110. In another non-limiting example, instead of including one overhang feature 130 and one snap-arm feature 132, valve receptacle 112 may include two snap-arm features 132.

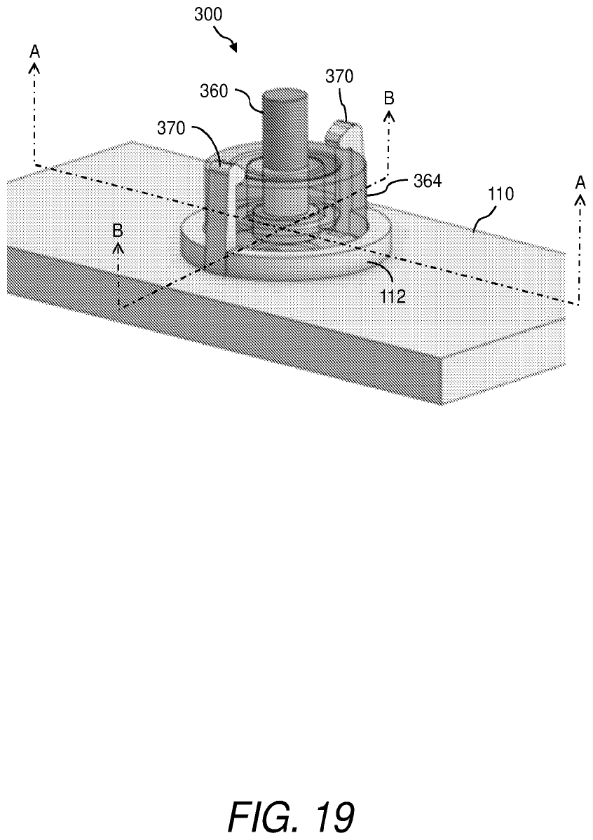

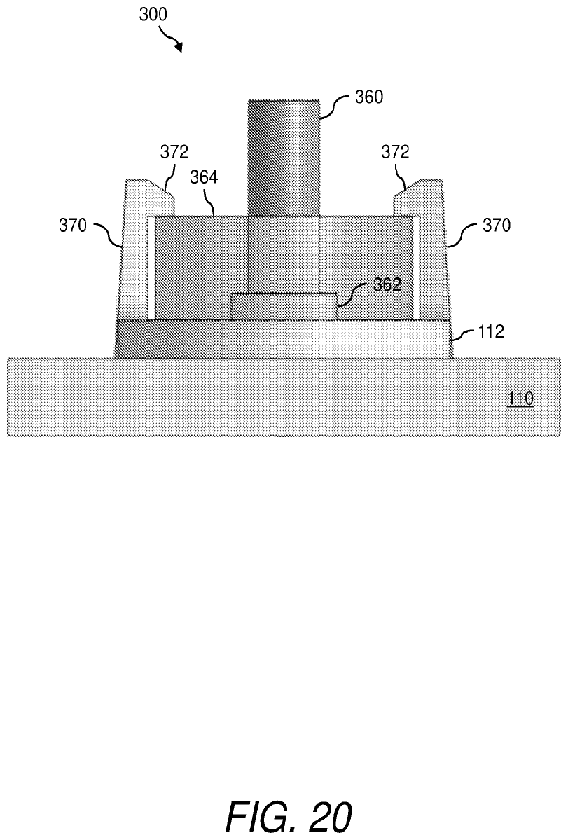

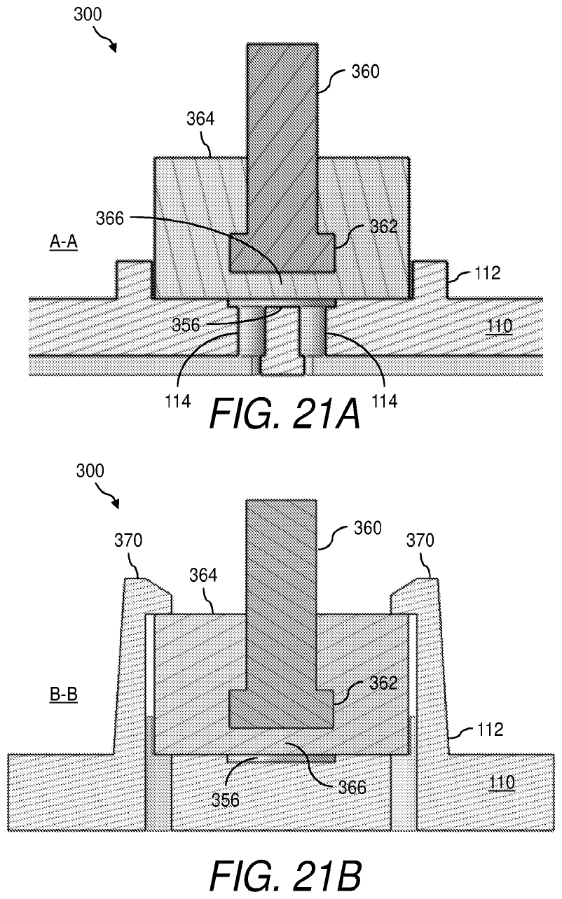

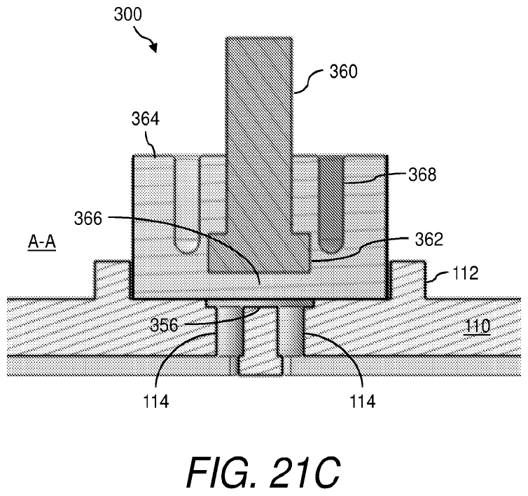

Referring now to FIG. 19 and FIG. 20 is a perspective view and a side view, respectively, of a non-limiting example of a modular pinch valve 300 having a snap-arm design. Further, FIG. 21A, FIG. 21B, and FIG. 21C is cross-sectional views of the snap-arm modular pinch valve 300 shown in FIG. 19. For example, FIG. 21A is a cross-sectional view taken along line A-A of the snap-arm modular pinch valve 300 shown in FIG. 19. FIG. 21B is a cross-sectional view taken along line B-B of the snap-arm modular pinch valve 300 shown in FIG. 19.

In this non-limiting example, the snap-arm modular pinch valve 300 may include a valve actuation pin 360 and valve body 364 fitted into the valve receptacle 112 of microfluidic device 110. A valve plunger 362 is provided at the distal end of valve actuation pin 360.

Valve actuation pin 360 may be formed, for example, of a rigid thermoplastic material whereas valve body 364 may be formed of an elastomeric (flexible) material, such as, but not limited to, silicone, hydrogel, PDMS, TPE material, and the like. In a specific non-limiting example, valve body 364 may be formed of TPE material having a durometer rating of about 40A. Accordingly, in one non-limiting example, a thermoplastic injection molding process may be used to first form valve actuation pin 360 of the rigid thermoplastic material. Then, in a next step of the thermoplastic injection molding process, a valve body 364 may be formed as an overmold of valve actuation pin 360. At the end of this process, valve actuation pin 360 and valve body 364 may be provided together as one component. Further, at the end of this process, valve body 364 may include a flex portion 366 at valve plunger 362 of valve actuation pin 360, as shown in FIG. 21A and FIG. 21B.

In operation, flex portion 366 may serve as the portion of valve body 364 that may be actuated via a valve actuator 190 pushing on valve actuation pin 360 and valve plunger 362. That is, flex portion 366 may be actuated in relation to space 356 and the two (2) fluid channels 114 of microfluidic device 110 to either allow flow or block flow. Generally, the snap-arm modular pinch valve 300 shown in FIG. 19 through FIG. 21B may be provided in the normally open state.

Further, a pair of snap arms 370 are provided at valve receptacle 112 and wherein the snap arms 370 protrude upward from microfluidic device 110. Accordingly, valve body 364 may be held in valve receptacle 112 using the snap arms 370 and wherein latch-ends 372 of snap arms 370 may engage with the edge of the valve body 364 as shown in FIG. 20. More specifically, valve body 364 with valve actuation pin 360 may be snap-fitted into valve receptacle 112 and held via the pair of snap arms 370. Valve receptacle 112 with snap arms 370 allows the perimeter of valve body 364 to be held in place with enough pressure to create a reliable seal against the surface of microfluidic device 110 and ensure flow through space 356 of microfluidic device 110 only.

Referring now to FIG. 21C is a cross-sectional view showing another non-limiting example of the snap-arm modular pinch valve 300 shown in FIG. 19 and FIG. 20. For example, FIG. 21C is a cross-sectional view taken along line A-A of the snap-arm modular pinch valve 300 shown in FIG. 19. The snap-arm modular pinch valve 300 is shown in FIG. 21C is substantially the same as the snap-arm modular pinch valve 300 shown in FIG. 19 through FIG. 21B except for that valve body 364 further includes a trough or cutout 368 in the material around valve actuation pin 360. The purpose of trough or cutout 368 may be, for example, to (1) provide slightly greater flexibility of valve body 364 compared with the solid valve body 364, and (2) reduce the amount of material needed for form valve body 364.

Further, in the snap-arm modular pinch valve 300 shown in FIG. 19 through FIG. 21C, the bond between valve actuation pin 360 and valve body 364 may be chemical, mechanical, or both chemical and mechanical.

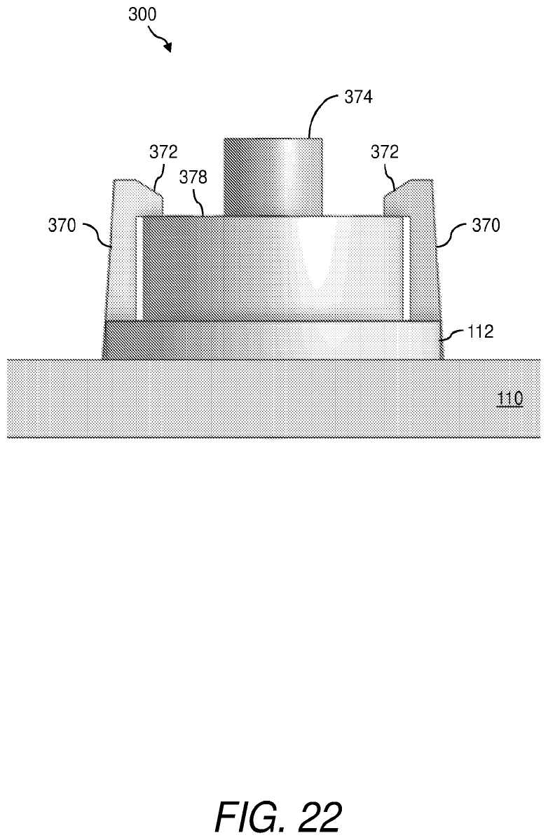

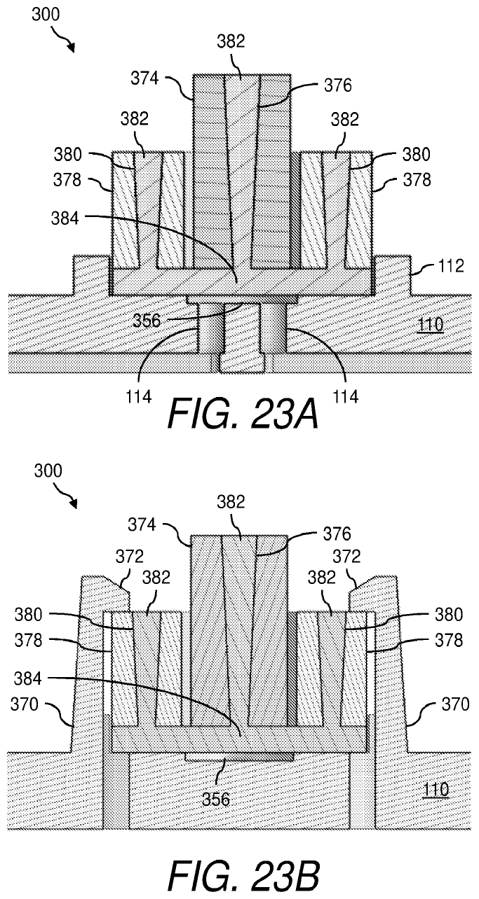

Referring now to FIG. 22 is a side view of another non-limiting example of a modular pinch valve 300 having a snap-arm design. Further, FIG. 23A and FIG. 23B is cross-sectional views of the snap-arm modular pinch valve 300 shown in FIG. 22. In this non-limiting example, both the valve actuation pin and the valve body may include a rigid outer portion of shell that is filled with elastomeric (flexible/compressible) material.

For example, FIG. 22 shows that snap-arm modular pinch valve 300 may include a valve actuation pin 374 and a valve body 378 that may be fitted into the valve receptacle 112 of microfluidic device 110. Like the snap-arm modular pinch valve 300 shown in FIG. 19 and FIG. 20, the valve body 378 may be held in valve receptacle 112 using the snap arms 370 and wherein latch-ends 372 of snap arms 370 may engage with the edge of the valve body 378.

FIG. 23A and FIG. 23B show more details of valve actuation pin 374 and valve body 378. More specifically, valve body 378 may be formed of two rigid rings (e.g., rigid thermoplastic material) arranged concentrically with a space 380 therebetween. Further, the walls of space 380 may be angled such that space 380 transitions from narrow to wide moving away from microfluidic device 110. Valve actuation pin 374 may be a rigid hollow cylinder (e.g., rigid thermoplastic material) that has a center space or channel 376. Further, the walls of the center space or channel 376 of valve actuation pin 374 may be angled such that the space 376 transitions from narrow to wide moving away from microfluidic device 110. Having arranged valve actuation pin 374 with respect to valve body 378, space 376 of valve actuation pin 374, and space 380 of the valve body 378 may be filled with elastomer material 382 (e.g., silicone, hydrogel, PDMS, TPE material). Further, a space in the plane below valve actuation pin 374 and valve body 378 may be filled with elastomer material 382 to form a flex portion 384 that substantially spans the area of valve receptacle 112. Further, flex portion 384 interconnects space 376 of valve actuation pin 374 and space 380 of the valve body 378.

Valve actuation pin 374 and valve body 378 may be formed, for example, of a rigid thermoplastic material whereas elastomer material 382 may be, for example, silicone, hydrogel, PDMS, TPE material, and the like. In a specific non-limiting example, valve actuation pin 374 and valve body 378 may be formed of TPE material having a durometer rating of about 40A. Accordingly, in one non-limiting example, a thermoplastic injection molding process may be used to first form valve actuation pin 374 and valve body 378 of the rigid thermoplastic material. Then, in a next step of the thermoplastic injection molding process, elastomer material 382 may be formed as an overmold to fill space 376 of valve actuation pin 374 and space 380 of the valve body 378 and to form flex portion 384. At the end of this process, valve actuation pin 374, valve body 378, and elastomer material 382 may be provided together as one component.

The purpose of the angled walls is to provide a mechanical bond between the rigid valve actuation pin 374 and elastomer material 382 and the rigid valve body 378 and elastomer material 382. Additionally, there may be a chemical bond between the rigid material of valve actuation pin 374 and valve body 378, and elastomer material 382.

In operation, flex portion 384 may serve as the portion of this snap-arm modular pinch valve 300 that may be actuated via a valve actuator 190 pushing on valve actuation pin 374. That is, flex portion 384 may be actuated in relation to space 356 and the two (2) fluid channels 114 of microfluidic device 110 to either allow flow or block flow. Generally, the snap-arm modular pinch valve 300 shown in FIG. 22, FIG. 23A, and FIG. 23B may be provided in the normally open state.

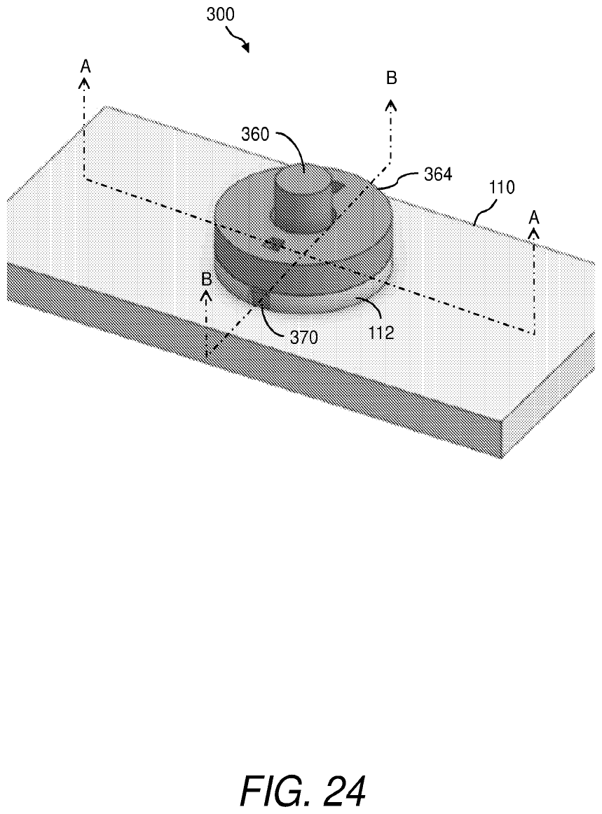

FIG. 19 through FIG. 23B, as shown hereinabove, may be configurations of modular pinch valves that include snap-arms integrated into the valve receptacle 112 of microfluidic device 110. For example, including snap arms 370 protruding upward from valve receptacle 112 of microfluidic device 110. By contrast, FIG. 24 through FIG. 33 below show other configurations of modular microvalves that include snap-arms integrated into the valve body and then snapping into microfluidic device 110.

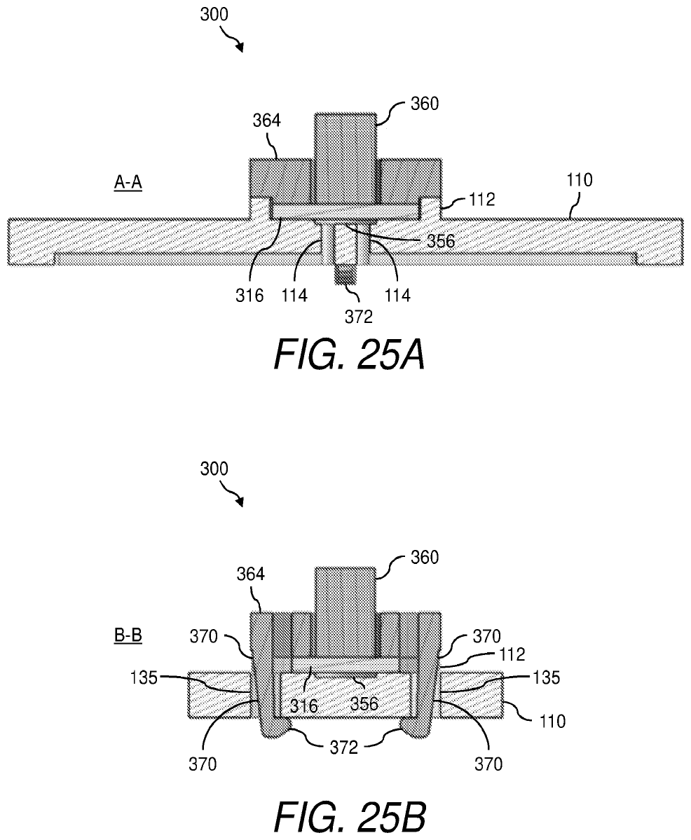

Referring now to FIG. 24 is a perspective view of yet another non-limiting example of a modular pinch valve 300 having a snap-arm design. Further, FIG. 25A and FIG. 25B is cross-sectional views of the snap-arm modular pinch valve 300 shown in FIG. 24. For example, FIG. 25A is a cross-sectional view taken along line A-A of the snap-arm modular pinch valve 300 shown in FIG. 24. FIG. 25B is a cross-sectional view taken along line B-B of the snap-arm modular pinch valve 300 shown in FIG. 24.

In this non-limiting example of modular pinch valve 300, the snap-arms are integrated into the valve body and are designed to snap into a microfluidic device 110. For example, FIG. 24 shows that snap-arm modular pinch valve 300 may include a valve actuation pin 360 and a valve body 364 that may be fitted into the valve receptacle 112 of microfluidic device 110. Additionally, the snap-arms 370 are integrated into the valve body 364 (see FIG. 25B). More specifically, a pair of snap-arms 370 protrude downward from valve body 364 and toward valve receptacle 112 of microfluidic device 110. Openings 135 in microfluidic device 110 are provided to receive snap-arms 370 and wherein latch-ends 372 of snap arms 370 may engage with the edge of microfluidic device 110 as shown in FIG. 25B.

FIG. 25A and FIG. 25B show more details of valve actuation pin 360 and valve body 364. More specifically, both valve actuation pin 360 and valve body 364 (including snap arms 370) may be formed, for example, of rigid thermoplastic material. Further, flexible membrane 316 may be provided that spans valve receptacle 112 atop space 356 of microfluidic device 110. Again, flexible membrane 316 may be formed of elastomeric (flexible) material, such as, but not limited to, silicone, hydrogel, PDMS, TPE material, and the like.

In operation, flexible membrane 316 may serve as the portion of this snap-arm modular pinch valve 300 that may be actuated via a valve actuator 190 pushing on valve actuation pin 360. That is, flexible membrane 316 may be actuated in relation to space 356 and the two (2) fluid channels 114 of microfluidic device 110 to either allow flow or block flow. Generally, the snap-arm modular pinch valve 300 is shown in FIG. 24, FIG. 25A, and FIG. 25B may be provided in the normally open state.

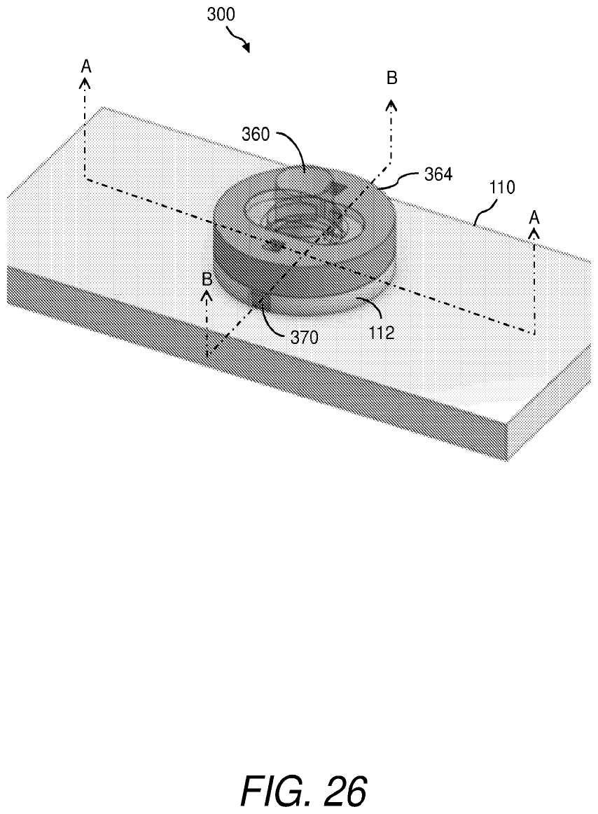

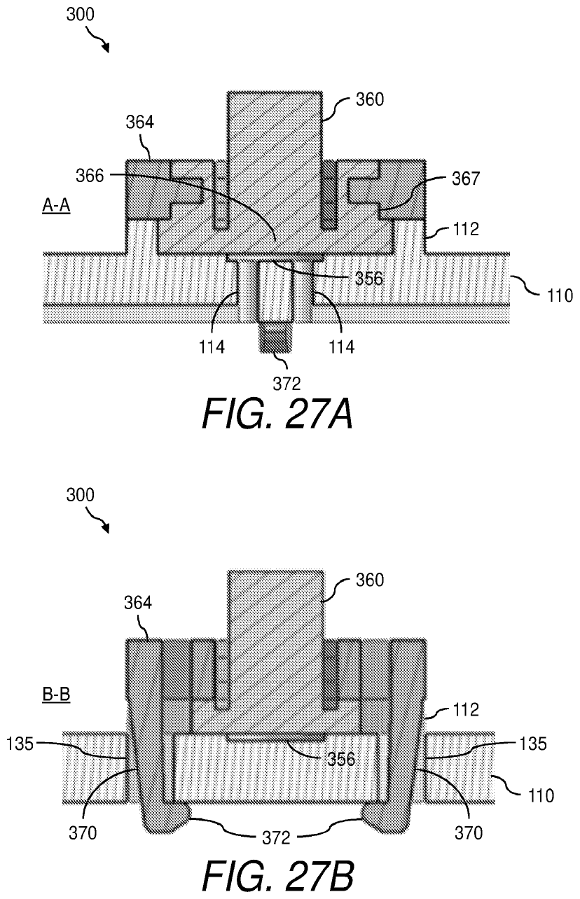

Referring now to FIG. 26 is a perspective view of yet another non-limiting example of a modular pinch valve 300 having a snap-arm design. Further, FIG. 27A and FIG. 27B is cross-sectional views of the snap-arm modular pinch valve 300 shown in FIG. 26. For example, FIG. 27A is a cross-sectional view taken along line A-A of the snap-arm modular pinch valve 300 shown in FIG. 26. FIG. 27B is a cross-sectional view taken along line B-B of the snap-arm modular pinch valve 300 shown in FIG. 26.

In this non-limiting example of modular pinch valve 300, the snap-arms are integrated into the valve body and are designed to snap into a microfluidic device 110. For example, FIG. 26 shows that snap-arm modular pinch valve 300 may include a valve actuation pin 360 and a valve body 364 that may be fitted into the valve receptacle 112 of microfluidic device 110. Additionally, the snap-arms 370 are integrated into the valve body 364 (see FIG. 27B). More specifically, a pair of snap-arms 370 protrude downward from valve body 364 and toward valve receptacle 112 of microfluidic device 110. Again, openings 135 in microfluidic device 110 are provided to receive snap-arms 370 and wherein latch-ends 372 of snap arms 370 may engage with the edge of microfluidic device 110 as shown in FIG. 27B.

FIG. 27A and FIG. 27B show more details of valve actuation pin 360 and valve body 364. More specifically, valve body 364 (including snap arms 370) may be formed, for example, of rigid thermoplastic material. Valve actuation pin 360 may be formed of elastomeric (flexible) material, such as, but not limited to, silicone, hydrogel, PDMS, TPE material, and the like. Further, valve actuation pin 360 may include the flex portion 366 that spans valve receptacle 112 atop space 356 of microfluidic device 110. Further, valve actuation pin 360 may include an outer portion 367 that may be used as a mechanical bond mechanism to valve body 364. That is, the rigid thermoplastic of valve body 364 encases the more flexible valve actuation pin 360 to form a mechanical bond.

The snap-arm modular pinch valve 300 is shown in FIG. 26, FIG. 27A, and FIG. 27B may be formed using a thermoplastic injection molding process. For example, first, the valve body 364 may be formed of rigid thermoplastic material via injection molding. Then, the valve actuation pin 360 may be formed of elastomeric (flexible) material (e.g., TPE material) as an overmold of the valve body 364. This could also be a two-part molding process. At the end of this process, valve actuation pin 360 and valve body 364 may be provided together as one component.

In operation, flex portion 366 may serve as the portion of this snap-arm modular pinch valve 300 that may be actuated via a valve actuator 190 pushing on valve actuation pin 360. That is, flex portion 366 may be actuated in relation to space 356 and the two (2) fluid channels 114 of microfluidic device 110 to either allow flow or block flow. Generally, the snap-arm modular pinch valve 300 shown in FIG. 26, FIG. 27A, and FIG. 27B may be provided in the normally open state.

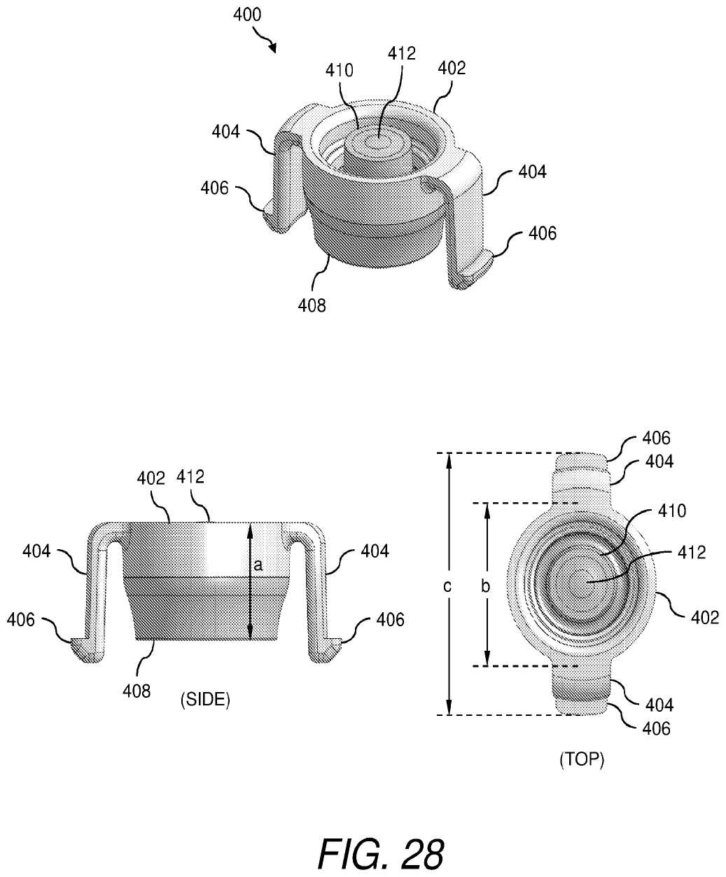

Referring now to FIG. 28 is a perspective view, a side view, and a top view of still another non-limiting example of a modular microvalve 400 having a snap-arm design. This variation of microvalve may also be termed a modular “pinch” valve. Like the snap-arm modular pinch valve 300 shown in FIG. 26, FIG. 27A, and FIG. 27B, the snap-arms of modular microvalve 400 are integrated into a valve supporter and are designed to “snap” into (i.e., be “mated” to, be “coupled” to, or be in a “sealable relationship” with) a microfluidic device 110. Generally, the design of modular microvalve 400 provides a compressible valve actuator (e.g., formed of silicone, hydrogel, PDMS, TPE material, or any other suitable compressible elastomeric material) seated in or otherwise held within a non-compressible (rigid) valve supporter (e.g., formed of polycarbonate (PC), acrylonitrile butadiene styrene (ABS), or any other suitable rigid thermoplastic material). Further, an inner chamber is present that is formed between an inner surface of the valve supporter and an outer surface of the valve actuator. The shape and arrangement of the inner chamber allow for the use of a lower compression force and, consequently, allow for the use of a lower valve “cracking” pressure. Stated another way, by including an inner chamber, the amount of material that needs to be compressed is reduced thereby allowing for the downward compression force on the valve actuator to be focused (channeled or distributed) over the fluid openings in the microfluidic device instead of being distributed over the full surface of the modular microvalve, i.e., allowing the valve actuator to move with less (compression) resistance.

In this non-limiting example, the modular microvalve 400 includes a valve supporter 402 that comprises a circular, non-compressible valve body that has an inner surface, an outer surface, a top surface, and a bottom surface, and that has at least two integrated snap-arms 404 coupled to the valve body. Each snap-arm 404 extends outwards from a side of the top outer surface of the valve supporter 402, and wherein each snap-arm comprises a shoulder feature, an outer flat component extending downwards from the shoulder feature, and a latch feature 406 at a proximal end of the outer flat component. Each snap-arm 404 has a latch feature 406 (on its proximal “latch-end”). Latch features correspond to snap-arms and are arranged or configured to couple (mate) the snap-arms of a modular microvalve to a valve receptacle, i.e., configured to allow for a snap-arm modular microvalve to be “snapped” into a corresponding valve receptacle. Additionally, the snap-arm modular microvalve 400 may include a valve actuator 408 seated within (or integrated within) the valve supporter 402. The compressible flex component 414 of the valve actuator 408 may further comprise a pin 410. The pin 410 may be a tapered cylinder or may be frustoconical in shape. The distal end (top) of pin 410 may also have a dimple feature 412 which may be compressible or rigid (non-compressible), wherein the dimple feature is configured to increase and more evenly distribute compression force when the compression force is applied to the pin, while the bottom of the valve actuator 408 may have a divot feature 416 provided on the bottom surface of the compressible flex component. The divot feature 416 may be configured to provide a flow space or channel that may be actuated (e.g., via the application of a compression force) in relation to space 356 (refer to FIGS. 27A and 27B) and the two (2) fluid channels 114 of microfluidic device 110 (refer to FIGS. 27A and 27B) to either allow flow (e.g., when uncompressed) or block flow (e.g., when compressed) (see FIG. 32). In this non-limiting example, the valve actuator includes a pin 410 and a dimple feature 412, as well as a divot feature 416, to form the valve actuator of the snap-arm modular microvalve 400. To show dimensional perspective, line “a” in FIG. 28 (SIDE) corresponds to the height of the modular microvalve (without the inclusion of the latch-ends of the snap-arms), which may be from about 3.6 mm to about 7.6 mm but is preferably about 5.6 mm (+/−1 mm). Line “b” in FIG. 28 (TOP) corresponds to the diameter of the modular microvalve without the snap-arms, which may be from about 6 mm to about 13 mm. Line “c” in FIG. 28 (TOP) corresponds to the diameter of the modular microvalve with the snap-arms, which may be from about 8 mm to about 15 mm.

In another non-limiting example, the valve actuator may comprise a partially-compressible flex component (with or without a bulge feature) in turn comprising a rigid dimple feature contained, embedded, housed, or otherwise fixed in a compressible flex structure, wherein the valve actuator is configured to block fluid flow when a compression force is applied to the rigid dimple feature and allow fluid flow when in an uncompressed state. The rigid dimple feature is preferably located at or near the center of the compressible flex structure and is configured to increase and more evenly distribute compression force when the compression force is applied to the pin.

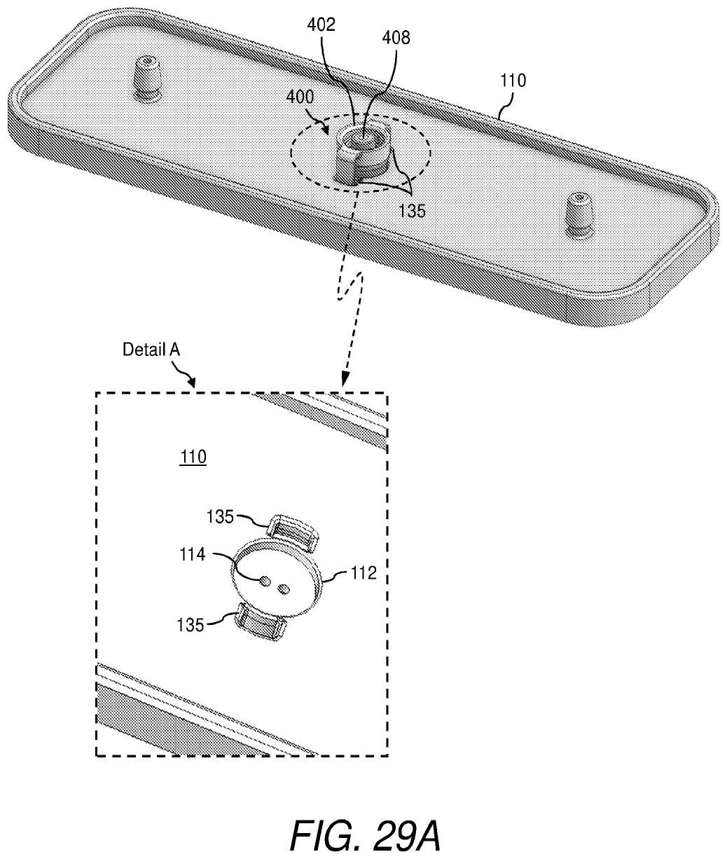

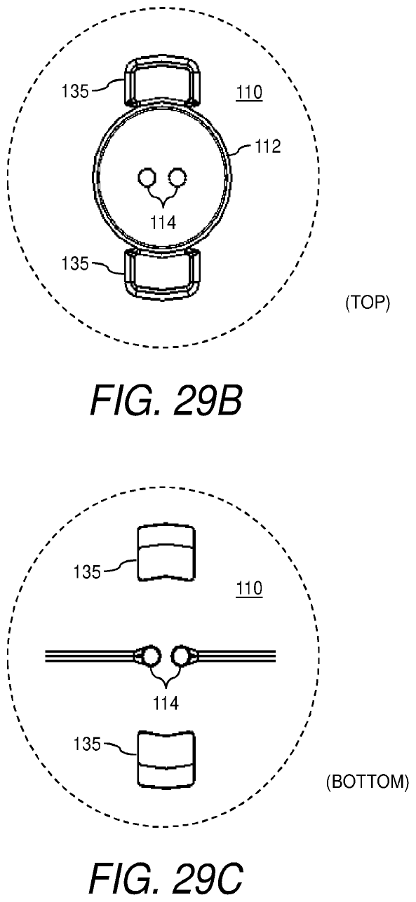

Further to the non-limiting example, FIG. 29A, FIG. 29B, and FIG. 29C shows more details of a microfluidic device 110 including the snap-arm modular microvalve 400 shown in FIG. 28. For example, FIG. 29A shows a perspective view of a non-limiting example of one snap-arm modular microvalve 400 installed in microfluidic device 110. A Detail A of FIG. 29A shows a non-limiting example of the valve receptacle 112-portion of microfluidic device 110 absent modular microvalve 400. Detail A shows that valve receptacle 112 may have a suitably smooth surface to ensure a reliable seal to the valve actuator 408-portion of modular microvalve 400. Detail A also shows more clearly the two (2) fluid channels 114 and two (2) openings 135 of microfluidic device 110 to which modular microvalve 400 may be mated or otherwise placed in a sealable relationship. Further, FIG. 29B and FIG. 29C shows a top view and a bottom view, respectively, of the valve receptacle 112-portion of microfluidic device 110 absent modular microvalve 400.

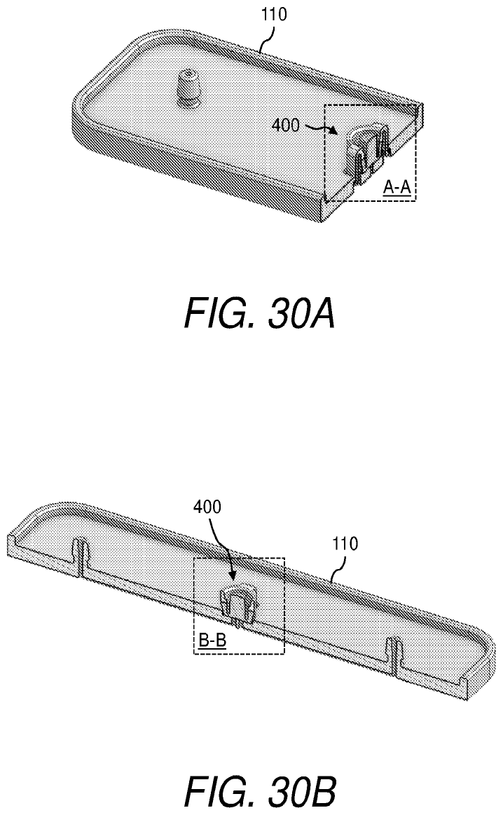

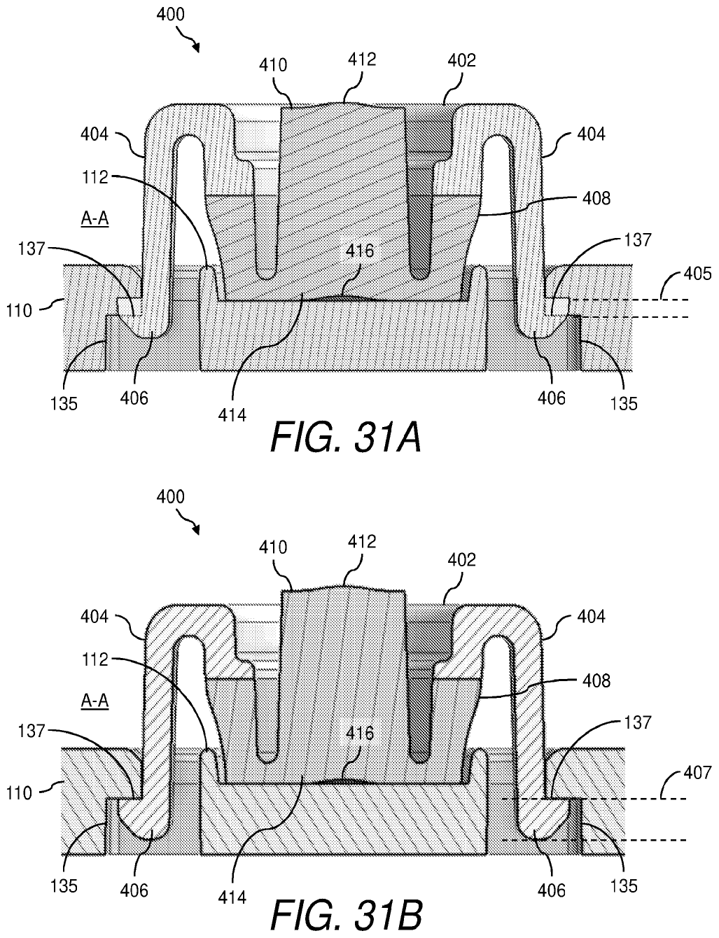

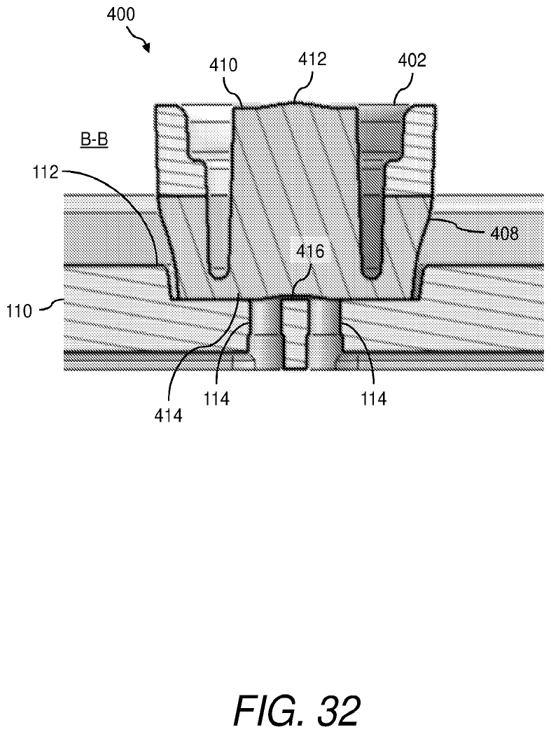

Referring now to FIG. 30A, FIG. 30B, FIG. 31A, FIG. 31B, and FIG. 32 is various cross-sectional views of microfluidic device 110 and snap-arm modular microvalve 400 shown in FIG. 29A. For example, FIG. 31A and FIG. 31B is cross-sectional views taken along line A-A of microfluidic device 110 shown in FIG. 30A. FIG. 32 is a cross-sectional view taken along line B-B of microfluidic device 110 shown in FIG. 30B.

Modular microvalve 400 may be formed using an injection molding process and a two-part mold. That is, first the rigid valve supporter 402 may be injection molded and then the elastomer valve actuator 408 may be molded onto the surfaces of the rigid valve supporter 402. In this non-limiting example, a chemical bond may exist between valve supporter 402 and valve actuator 408. In another non-limiting example, valve supporter 402 and valve actuator 408 may be formed separately and then bonded (or adhered) together. For example, elastomer valve actuator 408 may be formed independently via injection molding. Also, rigid valve supporter 402 may be formed independently via injection molding or 3D printing. Then, valve supporter 402 and valve actuator 408 may be adhered to or sealed together.

Referring now to FIG. 31A and FIG. 31B, modular microvalve 400 may be installed in a microfluidic device or cartridge (e.g., microfluidic device 110) by aligning the snap-arms 404 with their corresponding openings 135 in a microfluidic device 110 and pressing them into place, i.e., engagedly connecting the modular microvalve to the valve receptacle. Latch-ends 406 lock onto lip edges 137 in corresponding openings 135 of microfluidic device 110.

In modular microvalve 400, the elastomer valve actuator 408 must be under some compression to achieve an airtight seal within valve receptacle 112. For example, FIG. 31A and FIG. 31B shows the process of snapping modular microvalve 400 into the openings 135 of microfluidic device 110. That is, FIG. 31A shows modular microvalve 400 when partially installed while FIG. 31B shows modular microvalve 400 when fully installed. To illustrate the compression forces, FIG. 31A shows a non-limiting example of an arm interference region 405 during installation as compared with the full height 407 of latch-ends 406 shown in FIG. 31B.

To ensure a reliable seal between valve supporter 402 and valve actuator 408, the structure needs to be compressed the amount of the arm interference region 405. However, the length of the snap-arms 404 may vary to provide more or less compression to the elastomer valve actuator 408. The rim around valve receptacle 112 in microfluidic device 110 may allow some space for compression.

Referring now to FIG. 32, the slight divot feature 416 in the compressible flex component 414 of the valve actuator 408 allows modular microvalve 400 to operate in a normally open configuration, with fluid traveling through the valve unless compression force is applied at or near the center (middle) of pin 410 or (primarily or exclusively) to the dimple feature 412. In FIG. 32, the modular microvalve is shown in a “compressed” or “closed” state, thereby preventing fluid from flowing through (or between) the fluid channels 114. Further, the presence of the bulge feature 416 allows for a lower (reduced or significantly reduced) valve “cracking pressure”.

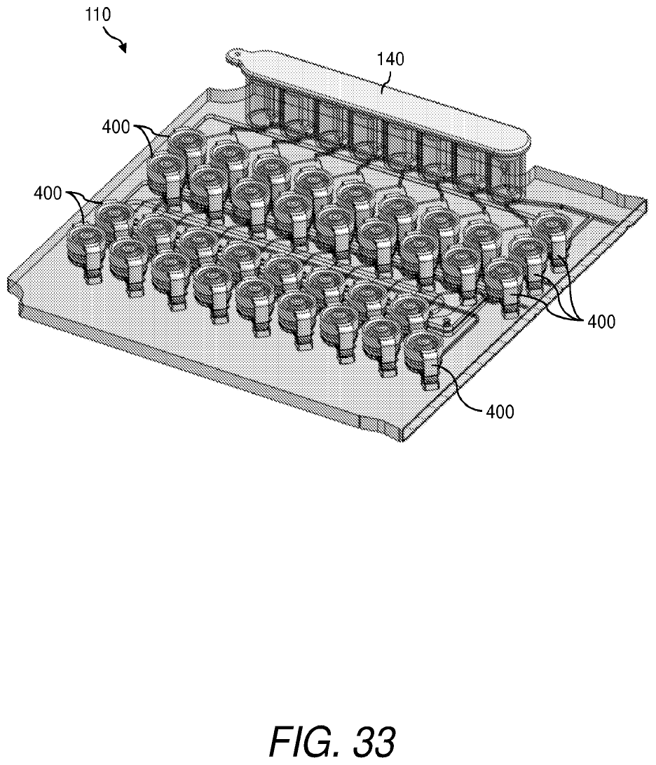

Referring now to FIG. 33 is a perspective view of a non-limiting example of a microfluidic device or cartridge (e.g., microfluidic device 110) including multiple snap-arm modular microvalves 400 shown in FIG. 28. In this non-limiting example, microfluidic device 110 may include any arrangements of multiple snap-arm modular microvalves 400. Microfluidic device 110 may also include one or more fluid input loading wells 140.

As a non-limiting example, FIG. 33 shows modular microvalves 400 coupled to a microfluidic device 110, together that may be termed an “assembly,” wherein the microfluidic device 110 may comprise: (i) one or more valve receptacles (not shown) protruding upward from a top surface of the microfluidic device and arranged to allow the modular microvalves to engagedly connect to the valve receptacles via the snap-arms; (ii) latch features (not shown) corresponding to the snap-arms arranged for engaging the snap-arms and thereby sealing the modular microvalve into the valve receptacle; (iii) one or more fluid openings (not shown) in fluid contact with corresponding fluid channels (not shown) arranged to allow for fluid communication between the fluid openings and the fluid channels; and (iv) one or more fluid input loading wells 140 in fluid communication with the fluid channels. Further, the modular microvalves 400 are arranged such that compression of the valve actuator prevents liquid flow from the fluid input loading wells 140 into the corresponding fluid openings. Generally, the assembly will comprise an “array” of microvalves and corresponding valve receptacles. Further, the modular microvalves 400 are actuatable between a “closed” configuration that inhibits fluid flow through the fluid openings into the fluid channels when the pin (or divot feature) is in a compressed state and an “open” or “uncompressed” configuration allowing fluid flow through the fluid openings into the fluid channels. This means that fluid can also be allowed to flow directly from the fluid input loading wells 140 through to the fluid openings and then into the fluid channels when the pin (or divot feature) is in an uncompressed (“open”) state. More specifically, modular microvalves 400 can be “tiled out” thereby allowing them to be configured in a series or in parallel. The “series” configuration allows for fluid to be directed into or out of a single fluid channel from branching fluid channels. The “parallel” configuration allows for the modular microvalves 400 to control fluid flow in parallel fluid channels. The microfluidic cartridge in FIG. 33 shows the modular microvalves 400 being used in both series and parallel configuration. In this non-limiting example, FIG. 33 shows four (4) modular microvalves 400 in a series configuration (shown from top-to-bottom along the right-hand side of the microfluidic device 110) thereby allowing for fluid to travel (flow) from a fluid input loading well 140 to either a fluid output well (not shown) or to a waste receptacle (not shown), while the parallel configuration of thirty-two (32) modular microvalves (shown from left-to-right along an x-y axis of the microfluidic device 110) is the same “series configuration” fluid flow “tiled out” eight (8) times, i.e., four (4) modular microvalves in a series configuration times eight (8) to form a parallel configuration of thirty-two (32) modular microvalves, thereby allowing for eight (8) separate fluid input loading wells 140 to flow fluid into either eight (8) separate fluid output wells (not shown) or into a joined waste receptacle (not shown).

The assembly may comprise an array of at least one (1) modular microvalve and a corresponding valve receptacle.

The assembly may comprise an array of up to at least eight (8) modular microvalves and corresponding valve receptacles.

The assembly may comprise an array of between one (1) and thirty-six (36) (or more) modular microvalves and corresponding valve receptacles.

The microfluidic device 110 may further comprise actuation means (not shown) for applying a compression force to the modular microvalves 400. The actuation means for applying the compression force may be selected from a group consisting of a solenoid and piston mechanism, a pneumatic mechanism, or other suitable means for applying a compression force to actuate (compress) the pin (or the dimple feature) of the valve actuator.

Generally, the overall diameter of modular microvalves 400 may range, for example, from about 8 mm to about 15 mm. However, in one non-limiting example, modular microvalve 400 may be designed to be placed on a 9-mm pitch (on center). Therefore, in this non-limiting example, the overall diameter of modular microvalves 400 may be just under 9 mm, such as 8 mm. In one non-limiting example, snap-arms 404 may extend out about 2 mm. However, the snap-arm 404 may be set to any distance away from valve supporter 402. For example, because openings 135 are required, the locations/positions of the snap-arms 404 may be optimized to not interfere with nearby fluid flow channels of microfluidic device 110.

In one non-limiting example, the overall height of the valve actuator 408 may be about from about 3.6 mm to about 7.6 mm but is preferably about 5.6 mm (+/−1 mm) including dimple feature 412. In one non-limiting example, dimple feature 412 may have a height of about 0.3 mm. To avoid accidental actuation, the designed height of pin 410 of the valve actuator 408 may be about the same as or slightly shorter than the height of the rigid valve supporter 402. Further, the height of pin 410 may be determined based on the forces needed to seal the valve using durometer 40A material. Again, in its relaxed (uncompressed) state, modular microvalve 400 is normally open. The divot feature 416 in the bottom surface of compressible flex component 414 of the valve actuator 408 provides a space that is suitably large to handle the volume of the flow in fluid channels 114. The divot feature 416 is also configured to decrease the “cracking pressure” of the modular microvalve 400.

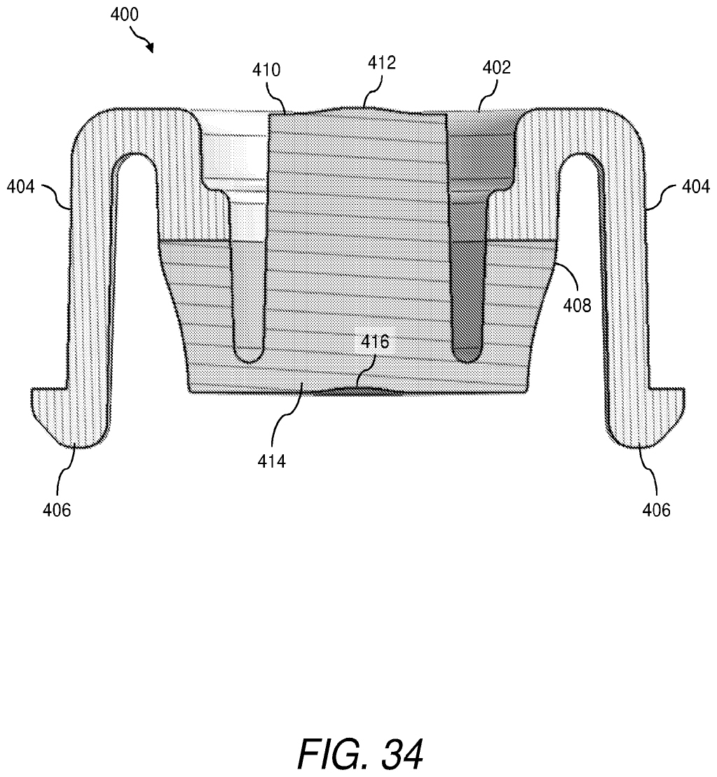

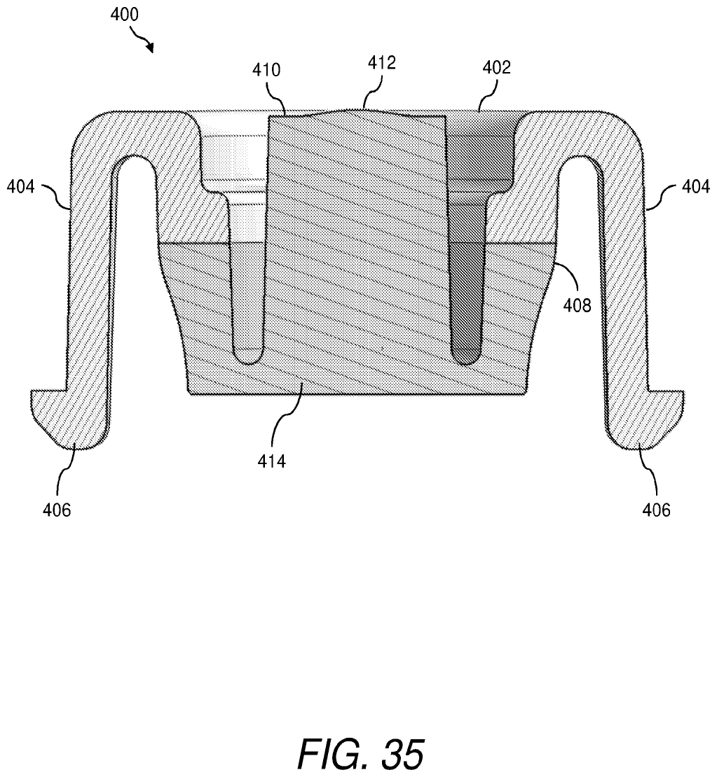

Referring now to FIG. 34, FIG. 35, and FIG. 36 is cross-sectional views of other non-limiting examples of the elastomeric valve actuator of the snap-arm modular microvalve 400 shown in FIG. 28 and showing various elastomer surface features. In one non-limiting example, FIG. 34 (and also FIG. 31A and FIG. 31B) shows valve actuator 408 including pin 410 with dimple feature 412, and divot feature 416, which is the elastomeric valve actuator of the snap-arm modular microvalve 400. In this configuration, the presence of divot feature 416 in the bottom surface of compressible flex component 414 of the valve actuator 408 may provide a normally open valve.

In another non-limiting example, FIG. 35 shows the pin 410 including dimple feature 412 and compressible flex component 414, but absent divot feature 416. Accordingly, compressible flex component 414 may be substantially flat. In this configuration, the presence of compressible flex component 414 with a substantially flat surface (i.e., absent divot feature 416) may provide a normally closed valve.

In yet another non-limiting example, FIG. 36 shows the pin 410 including dimple feature 412 and compressible flex component 414, and further including a bulge feature 418 extending outward from the bottom surface of compressible flex component 414. In this configuration, the presence of bulge feature 418 extending outward from the bottom surface of compressible flex component 414 may provide a normally closed valve. Additionally, the presence of bulge feature 418 extending outward from the bottom surface of compressible flex component 414 may provide a mechanism/feature configured to increase the “cracking pressure” of the modular microvalve 400.

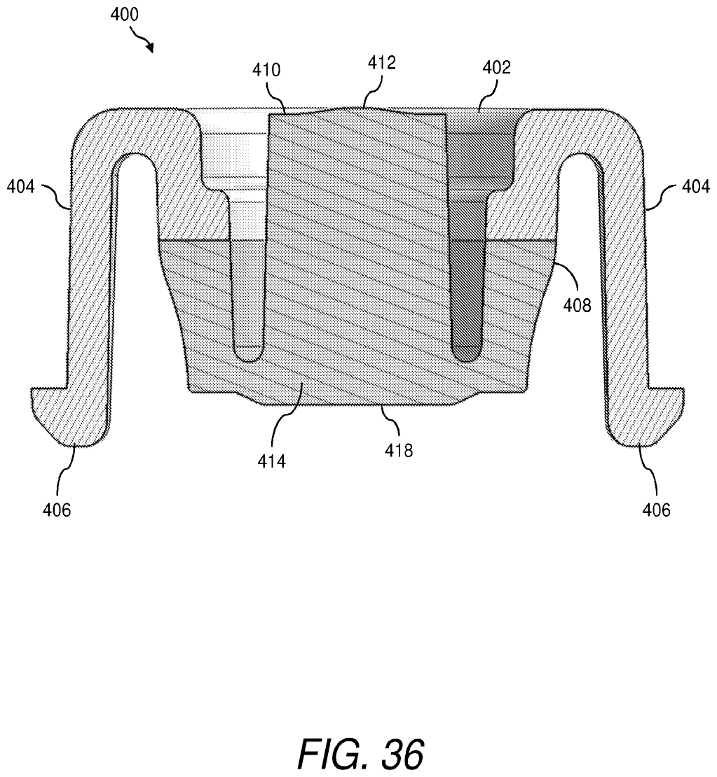

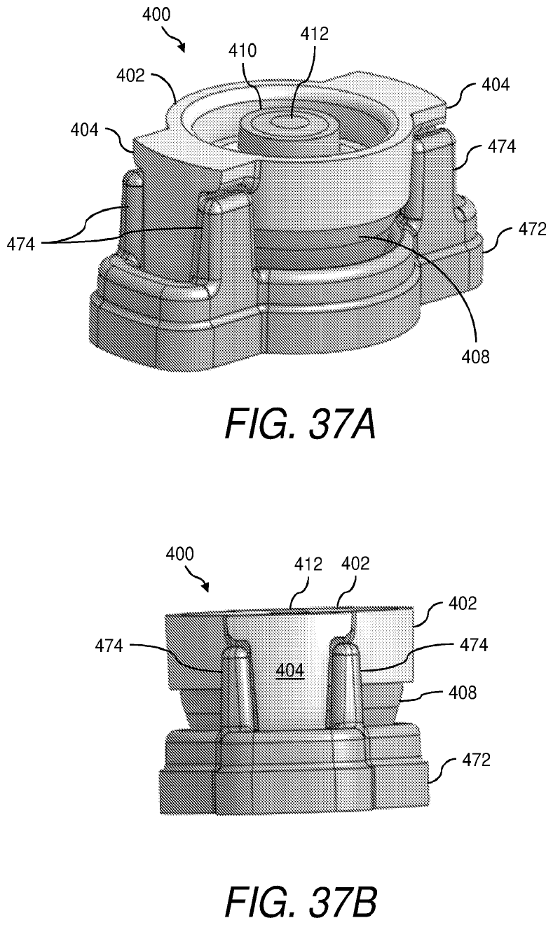

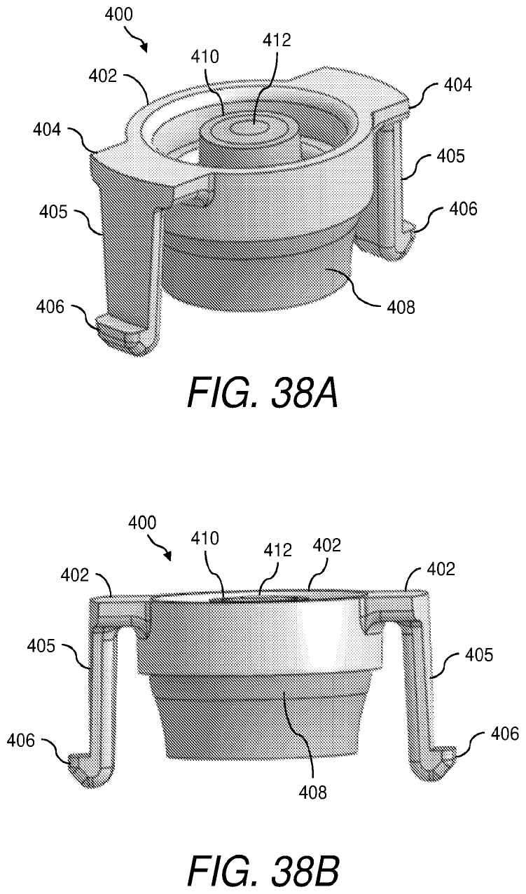

Referring now to FIG. 37A and FIG. 37B is perspective views of still another non-limiting example of snap-arm modular microvalve 400 and shown installed in a valve receptacle 472 including features that help index and align this snap-arm modular microvalve 400 to a microfluidic device (e.g., microfluidic device 110). Further, FIG. 38A and FIG. 38B are perspective views showing the snap-arm modular microvalve 400 shown in FIG. 37A and FIG. 37B alone.

As described above, snap-arm modular microvalve 400 may include valve supporter 402 with snap-arms 404 that have latch-ends 406. Again, snap-arm modular microvalve 400 may include valve actuator 408 that has compressible flex component 414 and pin 410 including dimple feature 412. However, in this non-limiting example, each of the snap-arms 404 of valve supporter 402 may further include an outer flat portion 405 leading down to its latch-end 406. Accordingly, valve receptacle 472 is designed to receive the snap-arms 404 having the outer flat portions 405. Additionally, valve receptacle 472 may include a pair of capture features 474 on each side. For example, valve receptacle 472 may include one pair of capture features 474 for each snap-arm 404 of snap-arm modular microvalve 400. Capture features 474 protrude upward from valve receptacle 472 and engage the sides of snap-arm 404.

In this non-limiting example, the outer flat portions 405 of snap-arms 404 of valve supporter 402 and the capture features 474 of valve receptacle 472 may be used to help index and align this snap-arm modular microvalve 400 to a microfluidic device (e.g., microfluidic device 110). For example, the “shoulder” features of the outer flat portions 405 of snap-arms 404 may act as “hard stops” on valve receptacle 472. Further, valve receptacle 472 may be a non-limiting example of valve receptacle 112 of microfluidic device 110 shown in FIG. 1 and FIG. 2.

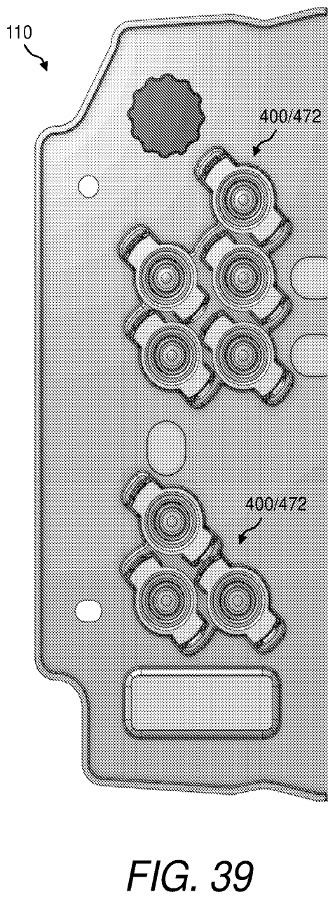

Referring now to FIG. 39 is a plan view of a portion of a non-limiting example of a microfluidic device or cartridge (e.g., microfluidic device 110) including multiple snap-arm modular microvalves 400 and valve receptacles 472 shown in FIG. 37A and FIG. 37B.

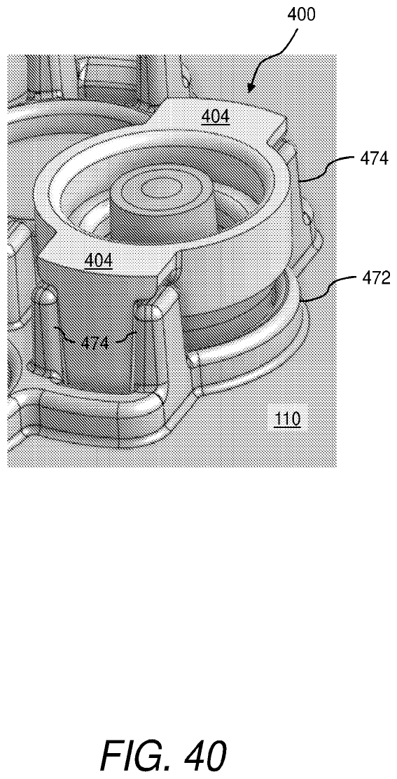

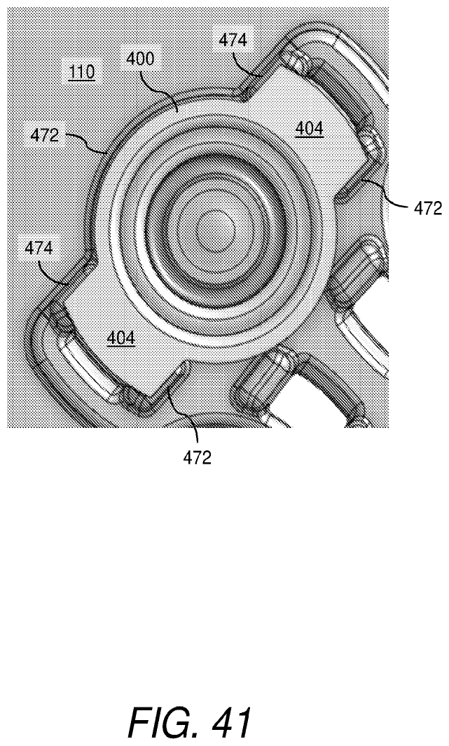

Referring now to FIG. 40 and FIG. 41 is a perspective view and a plan view, respectively, of a portion of the microfluidic device or cartridge shown in FIG. 30 including one snap-arm modular microvalve and valve receptacle shown in FIG. 37A and FIG. 37B.

### Other Modular Microvalve Designs

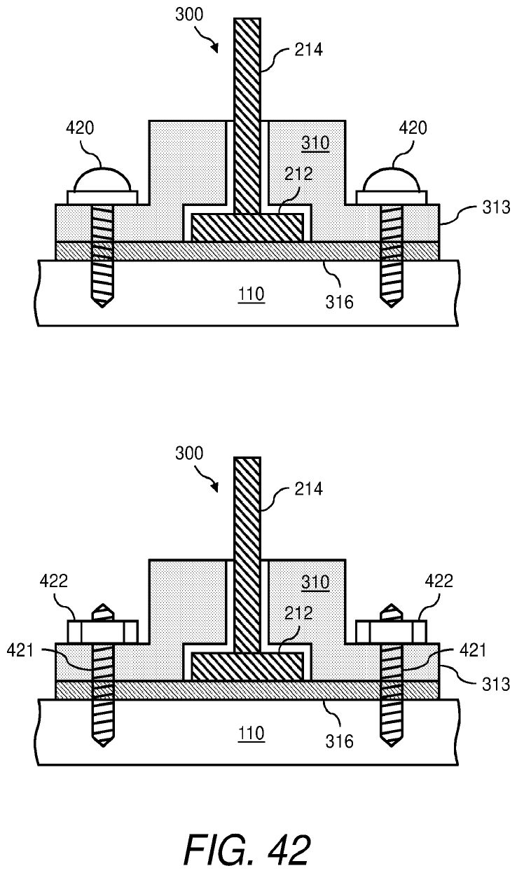

FIG. 42 through FIG. 60B shows non-limiting examples of other designs of the presently disclosed modular microvalves 120 for use in a microfluidic device, such as microfluidic device 110 of microfluidic system 100 shown in FIG. 1, FIG. 2, and FIG. 3.

Referring now to FIG. 42 is side views of non-limiting examples of modular pinch valve 300 secured to microfluidic device 110 via threaded elements. In this non-limiting example, modular pinch valve 300 includes rim or ridge 313 around valve body 310 and near flexible membrane 316. In one non-limiting example, a pair of screws 420 through rim or ridge 313 may be used to secure modular pinch valve 300 to microfluidic device 110. In another non-limiting example, a pair of threaded studs 421 is provided in microfluidic device 110. Then, rim or ridge 313 of modular pinch valve 300 is mounted on threaded studs 421. Then, nuts 422 are used to secure modular pinch valve 300 onto threaded studs 421.

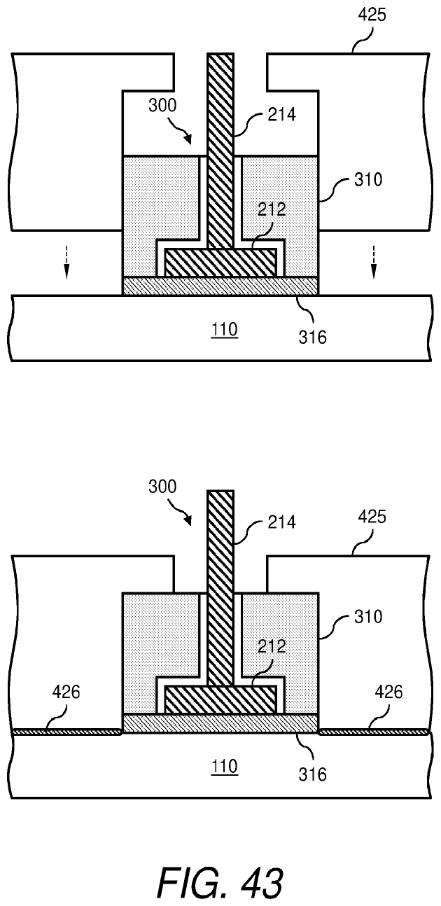

In other embodiments, modular pinch valve 300 may be secured to microfluidic device 110 via clamping mechanisms. In one non-limiting example and referring now to FIG. 43, a clamping shell 425 sits down onto valve body 310. Clamping shell 425 has an opening for valve actuation pin 214. In one non-limiting example, clamping shell 425 may be bonded to microfluidic device 110, as indicated by a bonding layer 426. For example, clamping shell 425 may be bonded via an adhesive, or by any welding process, such as, but not limited to, thermal welding, ultrasonic welding, solvent welding, and laser welding.

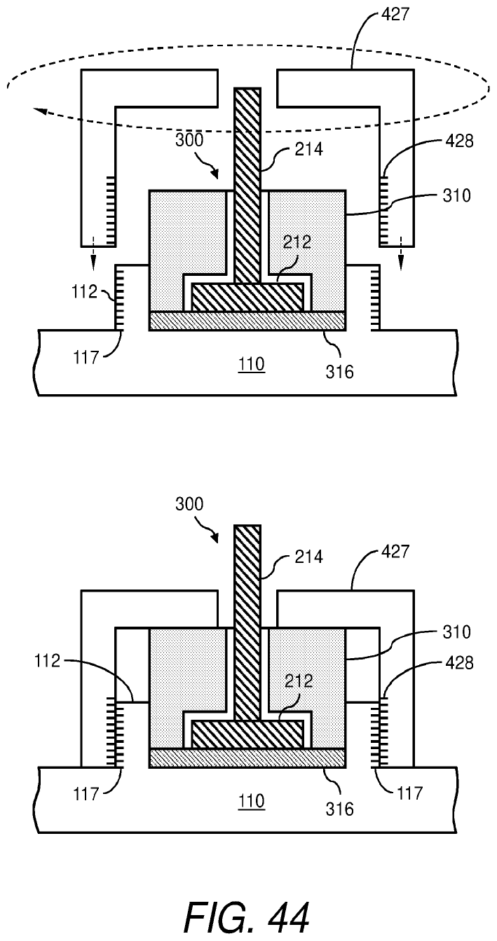

In another non-limiting example and referring now to FIG. 44, a threaded clamping shell 427 may be installed onto a threaded valve receptacle 112. Threaded clamping shell 427 has an opening for valve actuation pin 214 of modular pinch valve 300. Further, the inside wall of threaded clamping shell 427 is threaded (e.g., threads 428). In this non-limiting example, the outer portion of valve receptacle 112 is threaded (e.g., threads 117) and designed to receive threaded clamping shell 427. That is, after modular pinch valve 300 is installed in valve receptacle 112, threaded clamping shell 427 is slipped down over valve body 310 and threaded onto valve receptacle 112 using rotating action. That is, using rotating action, threads 428 of threaded clamping shell 427 engage with threads 117 of valve receptacle 112 until sufficient clamping force is present on modular pinch valve 300.

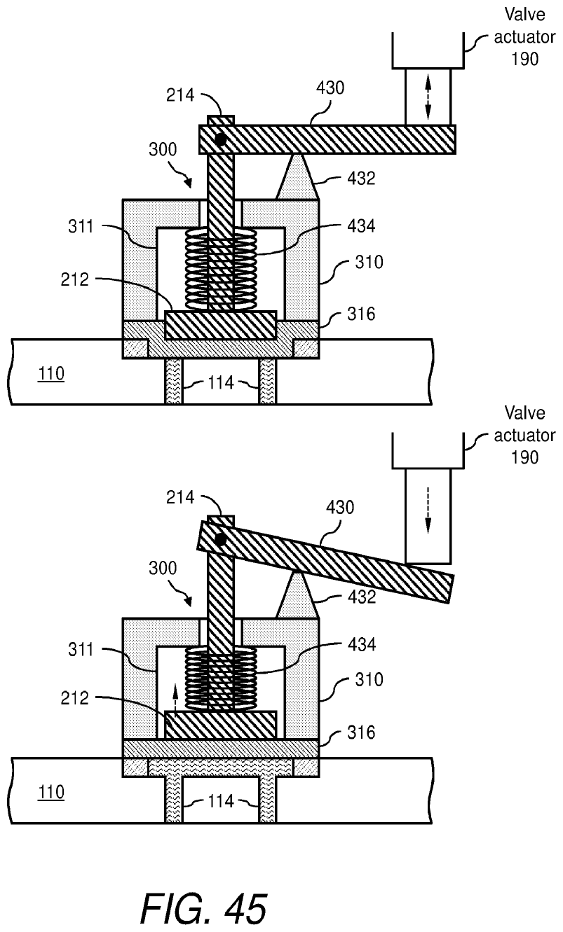

The presently disclosed modular microvalves 120, such as the various embodiments of modular pinch valve 300, are not limited to “normally open” or “default open” valves. In some embodiments, the presently disclosed modular microvalves may be “normally closed” or “default closed” valves. For example, FIG. 45 shows a non-limiting example of a normally-closed spring-loaded modular pinch valve 300 and a method of actuation. In this non-limiting example, modular pinch valve 300 further includes a spring 434 arranged inside cavity 311 and around valve actuation pin 214. In this way, a spring force is provided against valve plunger 212 and then flexible membrane 316. Accordingly, valve plunger 212 holds flexible membrane 316 deflected into the “positive” position (see FIG. 4B), which is the valve closed state.

In one non-limiting example, the normally-closed spring-loaded modular pinch valve 300 may be actuated (opened) using an actuation lever 430. One end of actuation lever 430 is pivotably coupled to the end of valve actuation pin 214. Further, actuation lever 430 is arranged atop a fulcrum 432. Then, valve actuator 190 may be used to push down on the opposite end of actuation lever 430. In this way, valve actuator 190 overcomes the spring force and raises valve actuation pin 214 and valve plunger 212. In so doing, flexible membrane 316 may return to the “neutral” position (see FIG. 4A), which is the valve open state.

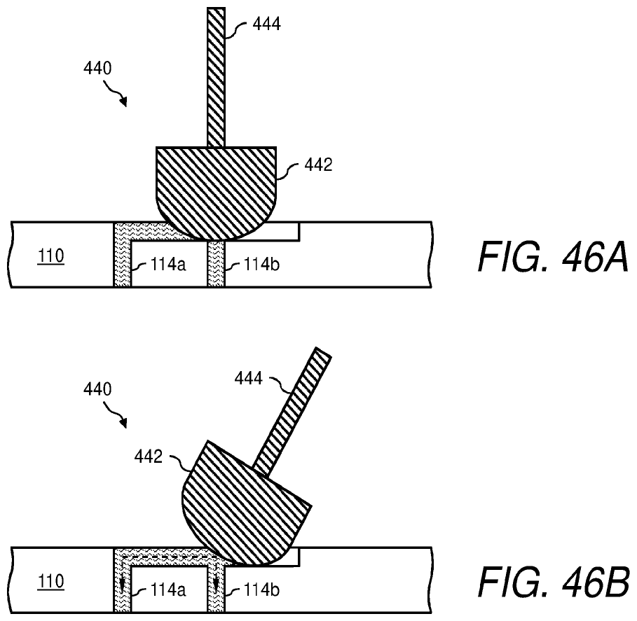

The presently disclosed modular microvalves are not limited to modular pinch valves only. Other types of modular microvalves are possible. Non-limiting examples of other types of modular microvalves are shown and described hereinbelow with reference to FIG. 46A through FIG. 52.

Referring now to FIG. 46A and FIG. 46B, a non-limiting example of a two-position modular rocker valve 440 is provided. Two-position modular rocker valve 440 is another non-limiting example of the presently disclosed modular microvalves 120 shown in FIG. 1 and FIG. 2. Two-position modular rocker valve 440 may include, for example, a rocker head 442 coupled to a rocker arm 444. Rocker head 442 may be, for example, a substantially semicircular-shaped head that can be manipulated (i.e., rocked) by moving rocker arm 444. For example, a certain type of valve actuator 190 (not shown) may be engaged with rocker arm 444 for moving two-position modular rocker valve 440. In this non-limiting example, the curved portion of rocker head 442 may be arranged with respect to two fluid channels 114 (e.g., 114a, 114b) of microfluidic device 110. For example, the vertex of rocker head 442 may be positioned directly at fluid channel 114b.

As shown in FIG. 46A, when rocker head 442 is set substantially normal to the plane of microfluidic device 110, the fluid channel 114b is blocked by rocker head 442. With two-position modular rocker valve 440 in this position, no flow may occur between fluid channels 114a and 114b, which is the valve closed state. By contrast and as shown in FIG. 46B, rocker head 442 may be rocked sideways (e.g., in a direction that is away from fluid channel 114a) such that fluid channel 114b is no longer blocked by rocker head 442. With two-position modular rocker valve 440 in this position, flow is allowed between fluid channels 114a and 114b, which is the valve open state. Accordingly, in this configuration, two-position modular rocker valve 440 may be used to (1) block flow between fluid channels 114a and 114b, as shown in FIG. 46A; and (2) allow flow between fluid channels 114a and 114b, as shown in FIG. 46B.

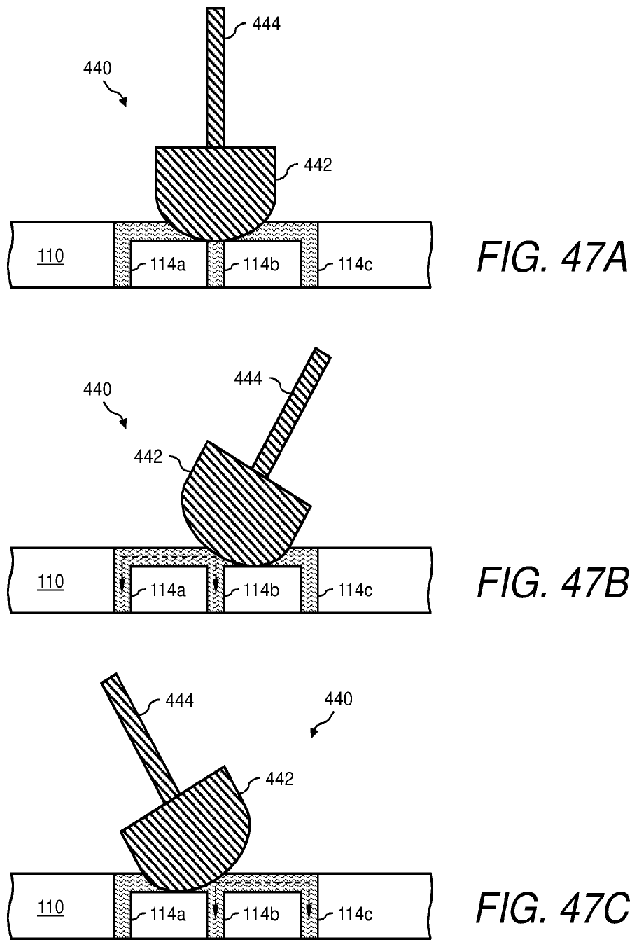

Referring now to FIG. 47A, FIG. 47B, and FIG. 47C, a non-limiting example of a three-position modular rocker valve 440 is provided. Three-position modular rocker valve 440 is another non-limiting example of the presently disclosed modular microvalves 120 shown in FIG. 1 and FIG. 2. Three-position modular rocker valve 440 is substantially the same as the two-position modular rocker valve 440 described in FIG. 46A and FIG. 46B except for that rocker head 442 is arranged with respect to three fluid channels 114 (e.g., 114a, 114b, 114c) of microfluidic device 110 instead of just two. Accordingly, in this configuration, three-position modular rocker valve 440 may be used to (1) block all flow between fluid channels 114a, 114b, 114c, as shown in FIG. 47A; (2) allow flow between fluid channels 114a and 114b while blocking flow between fluid channels 114b and 114c, as shown in FIG. 47B; and (3) allow flow between fluid channels 114b and 114c while blocking flow between fluid channels 114a and 114b, as shown in FIG. 47C.

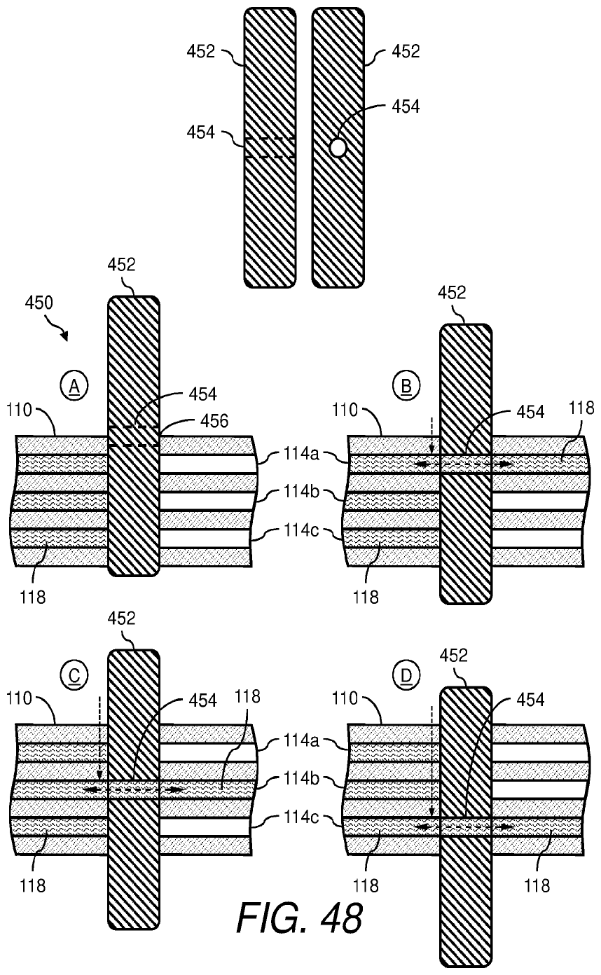

Referring now to FIG. 48, a non-limiting example of a modular slider valve 450 and a process of using modular slider valve 450 is provided. Modular slider valve 450 is another non-limiting example of the presently disclosed modular microvalves 120 shown in FIG. 1 and FIG. 2. In this non-limiting example, modular slider valve 450 may include a slider bar 452 that has at least one fluid channel 454 arranged along its length. In one non-limiting example, fluid channel 454 may be arranged about midway of the length of slider bar 452. Further, modular slider valve 450 includes microfluidic device 110 that may include one or more layers of fluid channels 114. In this non-limiting example, microfluidic device 110 includes three layers of fluid channels 114 (e.g., 114a, 114b, 114c). Further, in modular slider valve 450, an opening or through-hole 456 is provided in microfluidic device 110 and wherein through-hole 456 intersects the three fluid channels 114a, 114b, 114c. Further, through-hole 456 is sized to receive slider bar 452. That is, slider bar 452 may be held substantially normal to the plane of microfluidic device 110 and then inserted into through-hole 456 in a slidable fashion. Accordingly, in modular slider valve 450, slider bar 452 provides a pass-through selector mechanism.

Referring still to FIG. 48, in a step A, slider bar 452 may be inserted into through-hole 456 such that its fluid channel 454 is not aligned with any of the three fluid channels 114a, 114b, 114c. In this state, modular slider valve 450 may be considered fully “closed” because all three fluid channels 114a, 114b, 114c are blocked by the solid portions of slider bar 452.

Next, in a step B, slider bar 452 may be inserted into through-hole 456 such that its fluid channel 454 is both vertically and axially aligned with fluid channel 114a and not aligned with fluid channels 114b, 114c. In this state, modular slider valve 450 may be considered “open” for fluid channel 114a and “closed” for fluid channels 114b, 114c.

Next, in a step C, slider bar 452 may be further inserted into through-hole 456 such that its fluid channel 454 is both vertically and axially aligned with fluid channel 114b and not aligned with fluid channels 114a, 114c. In this state, modular slider valve 450 may be considered “open” for fluid channel 114b and “closed” for fluid channels 114a, 114c.

Next, in a step D, slider bar 452 may be further inserted into through-hole 456 such that its fluid channel 454 is both vertically and axially aligned with fluid channel 114c and not aligned with fluid channels 114a, 114b. In this state, modular slider valve 450 may be considered “open” for fluid channel 114c and “closed” for fluid channels 114a, 114b.

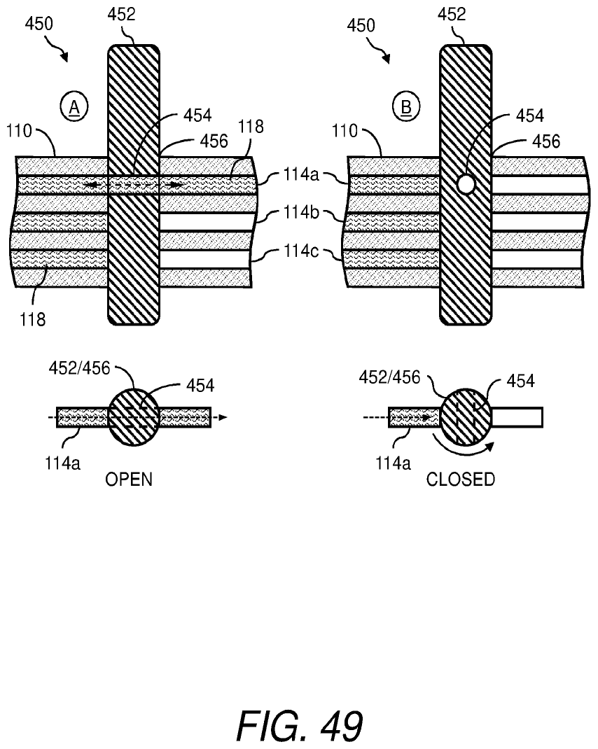

Referring now to FIG. 49, a non-limiting example of another process of using modular slider valve 450 shown in FIG. 48 is provided. That is, any individual fluid channel 114 may be opened and closed by a simple rotating slider bar 452 by 90 degrees. For example, in a step A, FIG. 49 shows fluid channel 454 of slider bar 452 both vertically and axially aligned with fluid channel 114a, which allows, for example, fluid 118 to flow freeing in fluid channel 114a. By contrast, in a step B, FIG. 49 shows slider bar 452 rotated such that its fluid channel 454 is still vertically aligned but not axially aligned with fluid channel 114a, which blocks fluid 118 from flowing in fluid channel 114a.

Referring now to FIG. 48 and FIG. 49, modular slider valve 450 is not limited to controlling three fluid channels 114 only. Modular slider valve 450 may include any number of fluid paths in slider bar 452 and microfluidic device 110. Further, modular slider valve 450 is not limited to only one fluid path open at a time. For example, slider bar 452 may include any number of fluid channels 454 that can be used to open simultaneously any number and/or combination of fluid paths in microfluidic device 110.

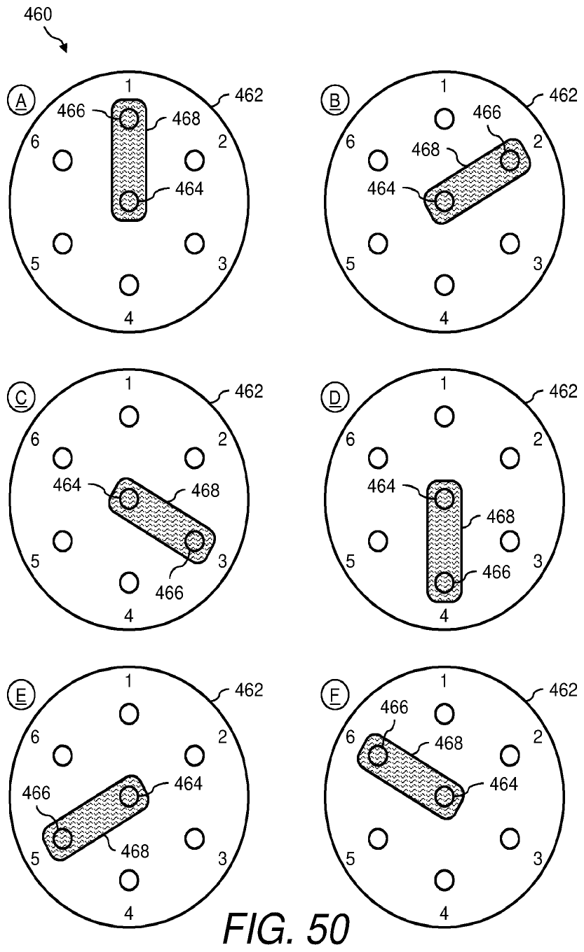

Referring now to FIG. 50, a non-limiting example of a single-channel modular rotary valve 460 and a process of using single-channel modular rotary valve 460 is provided. Single-channel modular rotary valve 460 is another non-limiting example of the presently disclosed modular microvalves 120 shown in FIG. 1 and FIG. 2. Single-channel modular rotary valve 460 may be considered a rotary switch/selector type of valve. In this non-limiting example, single-channel modular rotary valve 460 may provide a platform (or substrate) 462 that includes a center fluid port 464 surrounded radially by a plurality of fluid ports 466, such as six fluid ports 466. Further, single-channel modular rotary valve 460 may include a rotatable flow channel 468 that may be used to fluidly connect center fluid port 464 to any one of the six fluid ports 466.

While single-channel modular rotary valve 460 includes multiple fluid ports, “single-channel” means that only one fluid path at a time may be open. The one open fluid path may be selected by rotating flow channel 468 with respect to center fluid port 464 and the six fluid ports 466. For example, at a position A, flow channel 468 is rotatably set spanning center fluid port 464 and a first fluid port 466. Next, at a position B, flow channel 468 is rotatably set spanning center fluid port 464 and a second fluid port 466. Next, at a position C, flow channel 468 is rotatably set spanning center fluid port 464 and a third fluid port 466. Next, at a position D, flow channel 468 is rotatably set spanning center fluid port 464 and a fourth fluid port 466. Next, at a position E, flow channel 468 is rotatably set spanning center fluid port 464 and a fifth fluid port 466. Next, at a position F, flow channel 468 is rotatably set spanning center fluid port 464 and a sixth fluid port 466. In this non-limiting example, single-channel modular rotary valve 460 is configured such that center fluid port 464 is common to each of the six positions.

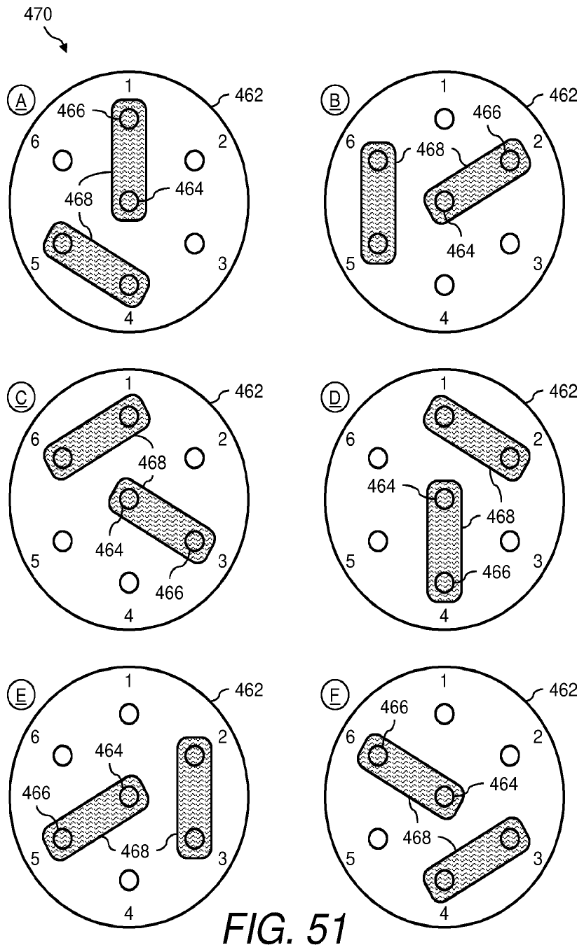

A modular rotary valve is not limited to opening only one fluid path at a time. A modular rotary valve may be designed to open multiple fluid paths simultaneously. By way of non-limiting example, FIG. 51 shows a multi-channel modular rotary valve 470. Multi-channel modular rotary valve 470 may be considered a rotary switch/selector type of valve. In this non-limiting example, multi-channel modular rotary valve 470 is a two-channel modular rotary valve that includes two rotatable flow channels 468. In this non-limiting example, multi-channel modular rotary valve 470 is configured such that center fluid port 464 is common to each of the six positions using the first flow channel 468. At the same time, the second flow channel 468 provides a unique flow path at each of the six (6) positions.

For example, and referring still to FIG. 51, at a position A, the first flow channel 468 is rotatably set spanning center fluid port 464 and the first fluid port 466, while the second flow channel 468 spans the fourth and fifth fluid ports 466. Next, at a position B, flow channel 468 is rotatably set spanning center fluid port 464 and the second fluid port 466, while the second flow channel 468 spans the fifth and sixth fluid ports 466. Next, at a position C, flow channel 468 is rotatably set spanning center fluid port 464 and the third fluid port 466, while the second flow channel 468 spans the first and sixth fluid ports 466. Next, at a position D, flow channel 468 is rotatably set spanning center fluid port 464 and the fourth fluid port 466, while the second flow channel 468 spans the first and second fluid ports 466. Next, at a position E, flow channel 468 is rotatably set spanning center fluid port 464 and the fifth fluid port 466, while the second flow channel 468 spans the second and third fluid ports 466. Next, at a position F, flow channel 468 is rotatably set spanning center fluid port 464 and the sixth fluid port 466, while the second flow channel 468 spans the third and fourth fluid ports 466.

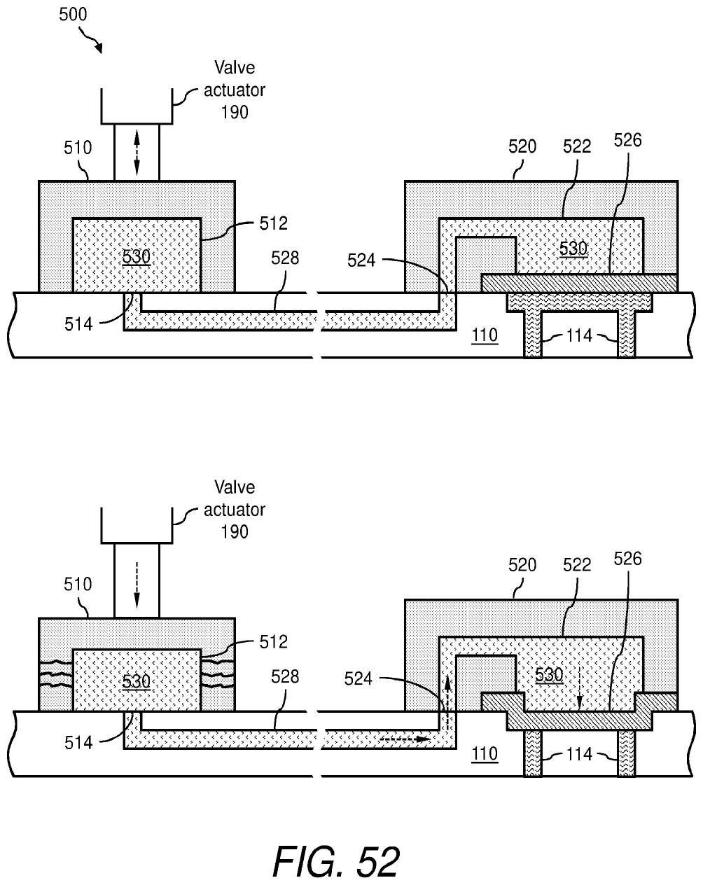

Referring now to FIG. 52 is side views of a non-limiting example of a puck-based modular pinch valve 500 in which the valve actuator may be located away from the location of the valve itself. In this non-limiting example, puck-based modular pinch valve 500 may include a control puck 510 and a valve puck 520 that are fluidly connected via microfluidic device 110. For example, control puck 510 may be a compressible body that includes a cavity 512 that has a fluid port 514. In one non-limiting example, puck-based modular pinch valve 500 may be an elastomeric material in which the top surface may bow inward and the walls may buckle outward. In another non-limiting example, puck-based modular pinch valve 500 may be an assembly of a rigid cylinder (e.g., plastic cylinder) with a deformable cap (e.g., silicone or polyurethane cap) that may compress like a “drumhead”. In yet another non-limiting example, puck-based modular pinch valve 500 may be an assembly of or a rigid cap (e.g., plastic cap) and deformable sidewalls (e.g., silicone or polyurethane sidewalls) may compress like an “accordion”.

Valve puck 520 may be a solid body that includes a cavity 522 that forms an opening across which is a flexible membrane 526. Flexible membrane 526 may be formed of an elastomeric (flexible) material, such as, but not limited to, silicone, hydrogel, PDMS, and the like. Flexible membrane 526 is provided to form a pinch valve with respect to the two (2) fluid channels 114 of microfluidic device 110. Additionally, valve puck 520 has a fluid port 524 that may be positioned, for example, to one side of cavity 522.

Both fluid port 514 of control puck 510 and fluid port 524 of valve puck 520 are oriented toward microfluidic device 110. Accordingly, control puck 510 and valve puck 520 may be fluidly connected via a fluid channel 528 in microfluidic device 110 that runs between fluid port 514 and fluid port 524. The continuous volume of cavity 512 of control puck 510, fluid channel 528, and cavity 522 of valve puck 520 may be filled with a flow medium 530. Flow medium 530 may be, for example, air, gas, or liquid, such as oil or water. In one non-limiting example, the amount of flow medium 530 in puck-based modular pinch valve 500 may be suitable for flexible membrane 526 to be in the “neutral” position when the pressure of flow medium 530 is at equilibrium.

FIG. 52 shows a valve actuator 190 in relation to control puck 510. In operation, sitting at equilibrium flexible membrane 526 of valve puck 520 may be in the “neutral” position and therefore puck-based modular pinch valve 500 is in the open state. That is, in the space beneath flexible membrane 526 there is a flow between the two fluid channels 114. Next, valve actuator 190 is activated to compress control puck 510, which pressurizes flow medium 530 in cavity 512. Accordingly, some amount of flow medium 530 is forced out of control puck 510 and into valve puck 520. Accordingly, the pressure of flow medium 530 above flexible membrane 526 of valve puck 520 increases, which causes flexible membrane 526 to deflect into the “positive” position (see FIG. 4B). In so doing, the flow of fluid between the two fluid channels 114 is blocked.

Puck-based modular pinch valve 500 may be useful in a scenario in which it may be desirable for the control of a valve to be located away from the location of the valve itself. For example, microfluidic device 110 may be designed such that all valve controls are at one particular location, such as near the cartridge edge and out of the way of other elements (e.g., thermal control, detection systems, magnets, etc.).

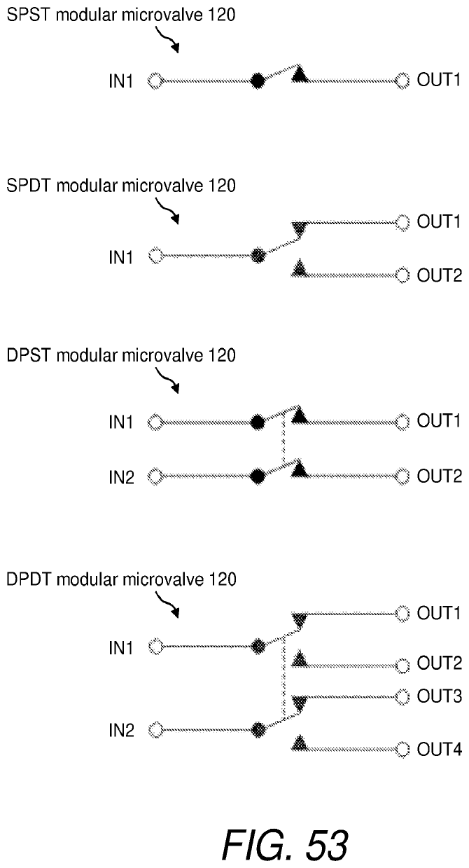

Referring now to FIG. 53 is schematic views of modular microvalves 120 that may be based on well-known electrical switch configurations. For example, a single-pole, single-throw (SPST) switch; a single-pole, a double-throw (SPDT) switch; a double-pole, single-throw (DPST) switch; and a double-pole, double-throw (DPDT) switch.

In one non-limiting example, FIG. 53 shows an SPST modular microvalve 120 that has one fluid input (IN1) supplying one fluid output (OUT1). In the valve open state, there is no flow between IN1 and OUT1. In the valve closed state, there is fluid flow between IN1 and OUT1. Non-limiting examples of an SPST modular microvalve 120 may include the modular pinch valve 200 shown in FIG. 4A and FIG. 4B, the adhesive-based modular pinch valve 250 shown in FIG. 5A through FIG. 7, any of the modular pinch valves 300 shown in FIG. 8A through FIG. 45, the two-position modular rocker valve 440 shown in FIG. 46A and FIG. 46B, and the puck-based modular pinch valve 500 shown in FIG. 52.

In another non-limiting example, FIG. 53 shows an SPDT modular microvalve 120 that has one (1) fluid input (IN1) supplying two (2) fluid outputs (OUT1, OUT2). In a first valve closed state, there is fluid flow between IN1 and OUT1. In a second valve closed state, there is fluid flow between IN1 and OUT2. There is no valve open (or no flow) state. A non-limiting example of an SPDT modular microvalve 120 may include the three-position modular rocker valve 440 shown in FIG. 47A, FIG. 47B, and FIG. 47C.

In yet another non-limiting example, FIG. 53 shows a DPST modular microvalve 120 that has a first fluid input (IN1) supplying a first fluid output (OUT1) as well as a second fluid input (IN2) supplying a second fluid output (OUT2), and including ganged control. For example, in a valve closed state there is fluid flow between IN1 and OUT1 and also fluid flow between IN2 and OUT2. In a valve open state, there is no fluid flow between IN1 and OUT1 and also no fluid flow between IN2 and OUT2. A non-limiting example of a DPST modular microvalve 120 may include a certain configuration of the modular slider valve 450 shown in FIG. 48 and FIG. 49.

In yet another non-limiting example, FIG. 53 shows a DPDT modular microvalve 120 that has a first fluid input (IN1) supplying two (2) fluid outputs (OUT1, OUT2) as well as a second fluid input (IN2) supplying two (2) different fluid outputs (OUT3, OUT4), and including ganged control. In a first valve closed state, there is fluid flow between IN1 and OUT1 and also fluid flow between IN2 and OUT3. In a second valve closed state, there is fluid flow between IN1 and OUT2 and also fluid flow between IN2 and OUT4. There is no valve open (or no fluid flow) state.

Further, an n-pole, single-throw (nPST) modular microvalve 120 may be provided, where n may be the number of inputs. Similarly, a single-pole, n-throw (SPnT) modular microvalve 120 may be provided, where n may be the number of outputs. Non-limiting examples of an SPnT modular microvalve 120 may include the single-channel modular rotary valve 460 shown in FIG. 50 and the multi-channel modular rotary valve 470 shown in FIG. 51.

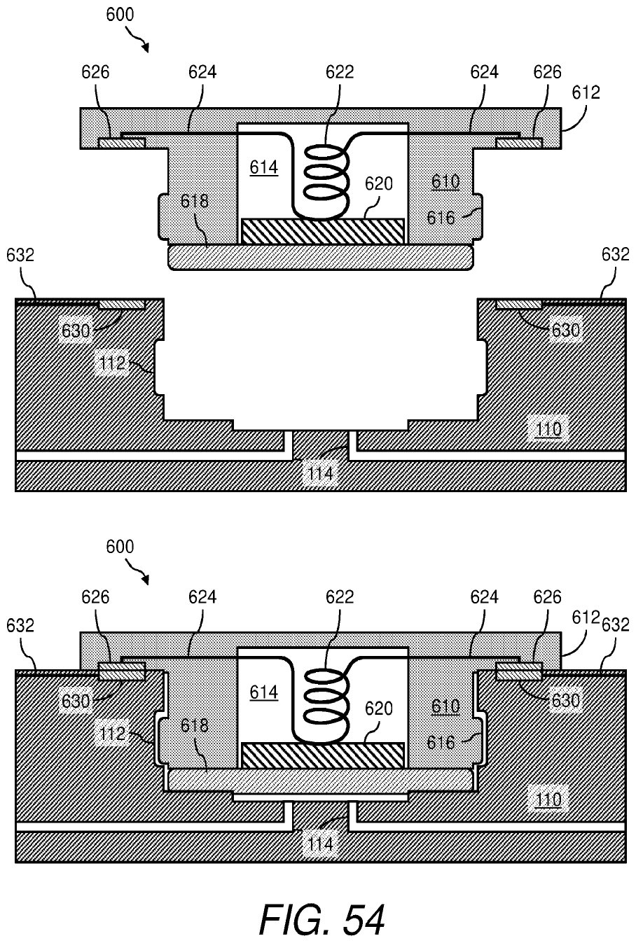

The presently disclosed modular pinch valves are not limited to being actuated via a mechanical actuator, such as valve actuators 190. Other actuation methods are possible. For example, and referring now to FIG. 54, side views are shown of a non-limiting example of an SMA-based modular pinch valve 600 that may be actuated via the action of an SMA element. A shape-memory alloy (SMA) is an alloy that can be deformed when cold but returns to its pre-deformed (“remembered”) shape when heated. Non-limiting examples of SMA material include, but are not limited to, copper-aluminum-nickel and nickel-titanium (NiTi). Alloys of zinc, copper, gold, and iron are also possible. Generally, SMA materials shrink when they are heated. The SMA-based modular pinch valve 600 is another non-limiting example of the presently disclosed modular microvalves 120 shown in FIG. 1 and FIG. 2.

SMA-based modular pinch valve 600 may include a snap-fit design. SMA-based modular pinch valve 600 may include, for example, a valve body 610 that has a top plate 612 and a cavity 614. Further, a snap feature 616 may be provided around the outside of valve body 610. A flexible membrane 618 spans the opening of valve body 610 facing valve receptacle 112 of microfluidic device 110. Flexible membrane 618 may be formed of an elastomeric (flexible) material, such as, but not limited to, silicone, hydrogel, PDMS, and the like. Further, a valve plunger 620 is provided in cavity 614 of valve body 610 and against flexible membrane 618. Further, an SMA spring 622 is arranged in cavity 614 of valve body 610 and against valve plunger 620. An electrical connection is provided to SMA spring 622 via a pair of embedded wires 624 in top plate 612. Each of the embedded wires 624 is electrically connected to an electrical contact pad 626.

To accommodate SMA-based modular pinch valve 600, valve receptacle 112 of microfluidic device 110 is shaped to receive SMA-based modular pinch valve 600. Further, microfluidic device 110 may include a pair of electrical contact pads 630 that are positioned to mate with electrical contact pads 626 of SMA-based modular pinch valve 600. Further, embedded wires 632 in microfluidic device 110 lead to an external control signal (not shown) for controlling SMA spring 622 of pair of SMA-based modular pinch valve 600.

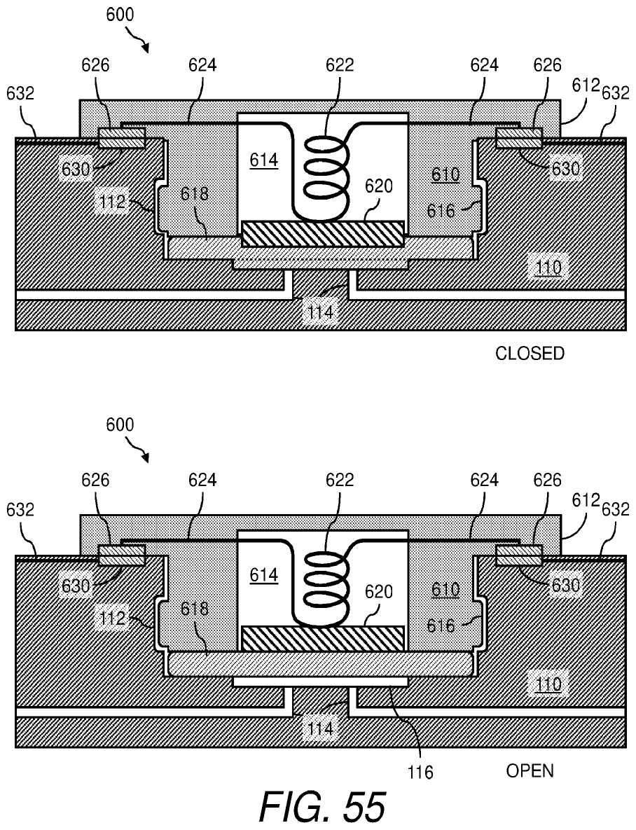

Referring now to FIG. 55, SMA-based modular pinch valve 600 may provide a “normally closed” or “default close” valve. In SMA-based modular pinch valve 600, SMA spring 622 expands when cooled and shrinks when is heated. The heating can be accomplished by flowing current through SMA spring 622 via embedded wires 624 and electrical contact pads 626. Accordingly, in the deactivated state with no current flowing, which is the cooled and expanded state, SMA spring 622 may be used to close SMA-based modular pinch valve 600 by applying pressure onto valve plunger 620, closing the fluid path. By contrast, in the activated state with current flowing, which is the heated and shrunken state, SMA spring 622 may be used to open SMA-based modular pinch valve 600 because no pressure is applied onto valve plunger 620, opening the fluid path. In this way, SMA spring 622 may be used to control valve plunger 620 without the need for an external actuator or pin.

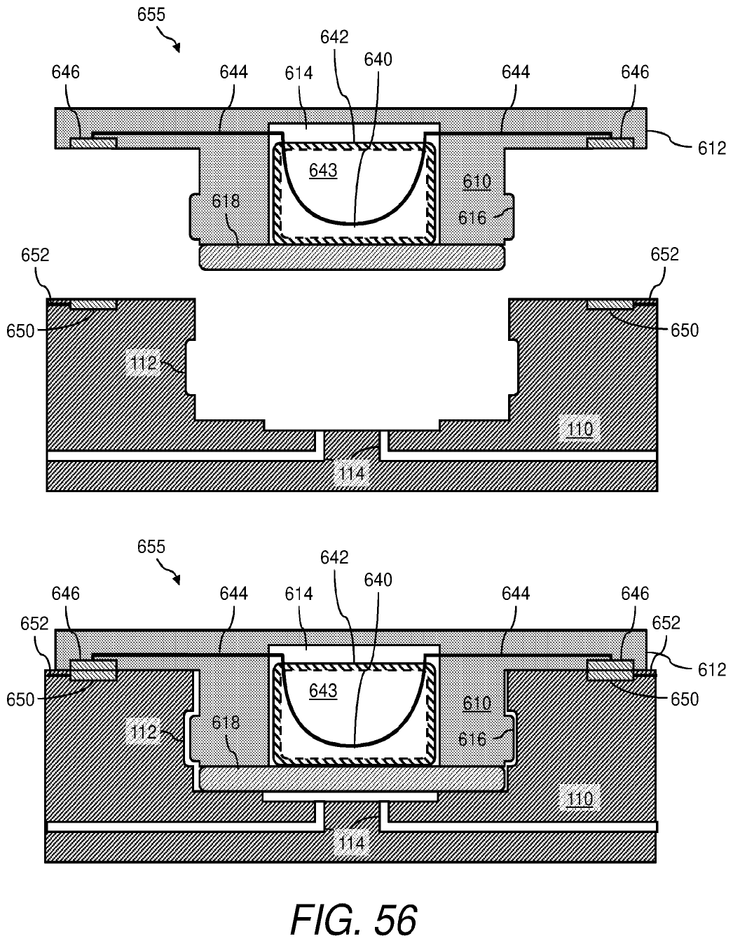

In another non-limiting example and referring now to FIG. 56, side views are shown of a non-limiting example of an SMA-based modular pinch valve 655 that may be actuated via the action of an SMA element. The SMA-based modular pinch valve 655 is another non-limiting example of the presently disclosed modular microvalves 120 shown in FIG. 1 and FIG. 2. SMA-based modular pinch valve 655 is substantially the same as SMA-based modular pinch valve 600 described in FIG. 54 and FIG. 55 except that valve plunger 620 and SMA spring 622 are replaced with a U-shaped SMA wire 640 embedded into a hollow valve plunger 642 that has a cavity 643. The curved portion of U-shaped SMA wire 640 protrudes into cavity 643. Hollow valve plunger 642 may be formed of a rigid non-electrically conductive material that is capable of handling the heat of U-shaped SMA wire 640 when activated. An electrical connection is provided to U-shaped SMA wire 640 via embedded wires 644 and electrical contact pads 646 in top plate 612. These connections mate to embedded wires 652 and electrical contact pads 650 in microfluidic device 110.

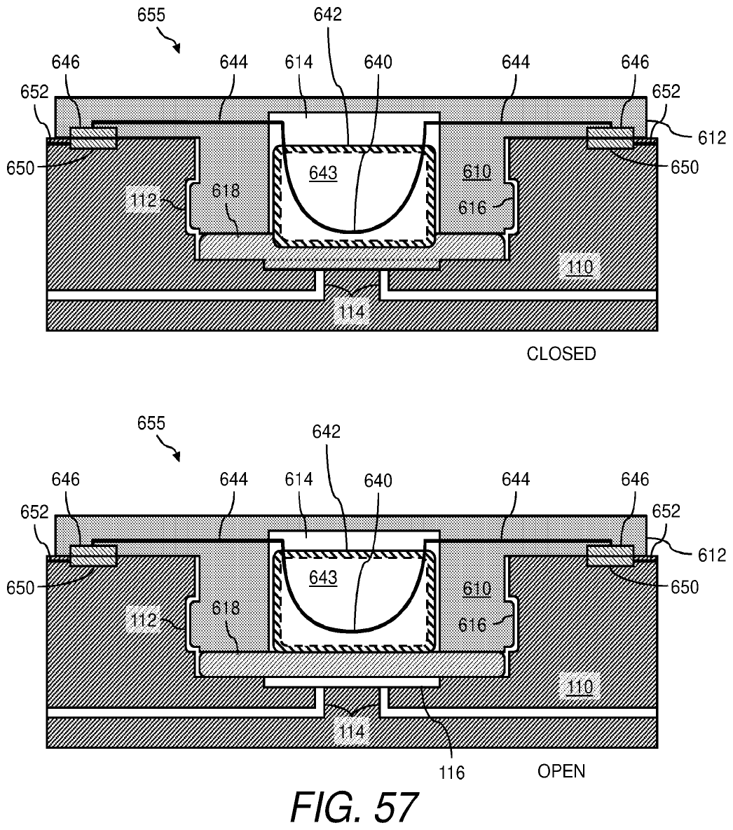

Referring now to FIG. 57, SMA-based modular pinch valve 655 may provide a “normally closed” or “default close” valve. In SMA-based modular pinch valve 655, U-shaped SMA wire 640 expands when cooled and shrinks when is heated. The heating can be accomplished by flowing current through U-shaped SMA wire 640 via embedded wires 644 and electrical contact pads 646. Accordingly, in the deactivated state with no current flowing, which is the cooled and expanded state, U-shaped SMA wire 640 may be used to close SMA-based modular pinch valve 655. This is due to the hollow valve plunger 642 being pushed toward and against flexible membrane 618 by the expanded U-shaped SMA wire 640, which closes the fluid path. By contrast, in the activated state with current flowing, which is the heated and shrunken state, U-shaped SMA wire 640 may be used to open SMA-based modular pinch valve 655. This is due to the hollow valve plunger 642 being pulled away from flexible membrane 618 by the shrunken U-shaped SMA wire 640, which opens the fluid path. In this way, U-shaped SMA wire 640 may be used to control hollow valve plunger 642 without the need for an external actuator or pin.

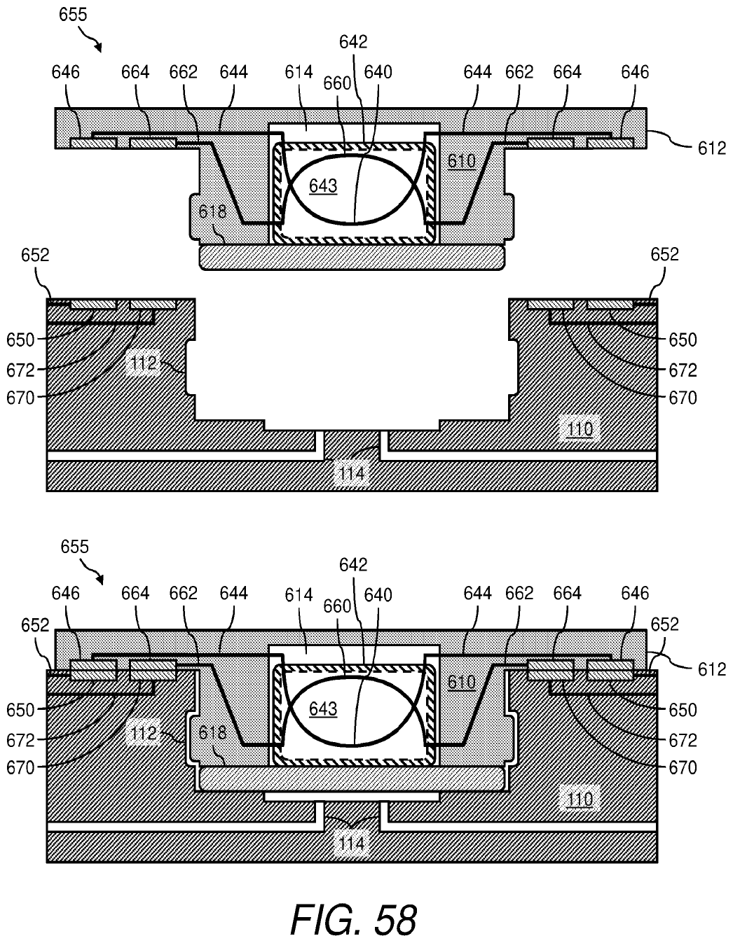

In another non-limiting example, FIG. 58 shows an embodiment of SMA-based modular pinch valve 655 that includes the right-side-up U-shaped SMA wire 640 shown in FIG. 56 and FIG. 57 as well as an upside-down U-shaped SMA wire 660. An electrical connection is provided to the up-side-down U-shaped SMA wire 660 via embedded wires 662 and electrical contact pads 664 in top plate 612. These connections mate to embedded wires 672 and electrical contact pads 670 in microfluidic device 110. The right-side-up U-shaped SMA wire 640 and the up-side-down U-shaped SMA wire 660 provide opposing action in SMA-based modular pinch valve 655. Accordingly, right-side-up U-shaped SMA wire 640 and up-side-down U-shaped SMA wire 660 may be controlled in any manner to accomplish a functional pinch valve. Further, in another non-limiting example, an SMA-based modular pinch valve may be provided that includes the up-side-down U-shaped SMA wire 660 only.

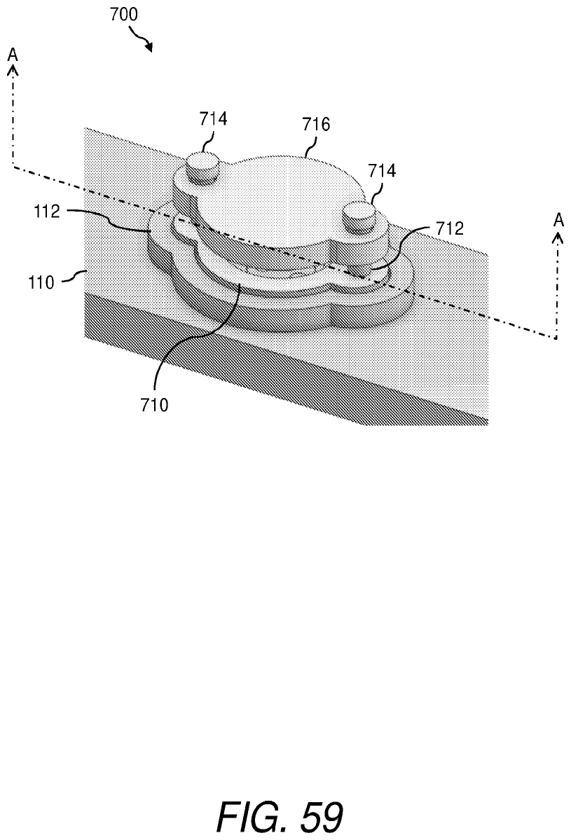

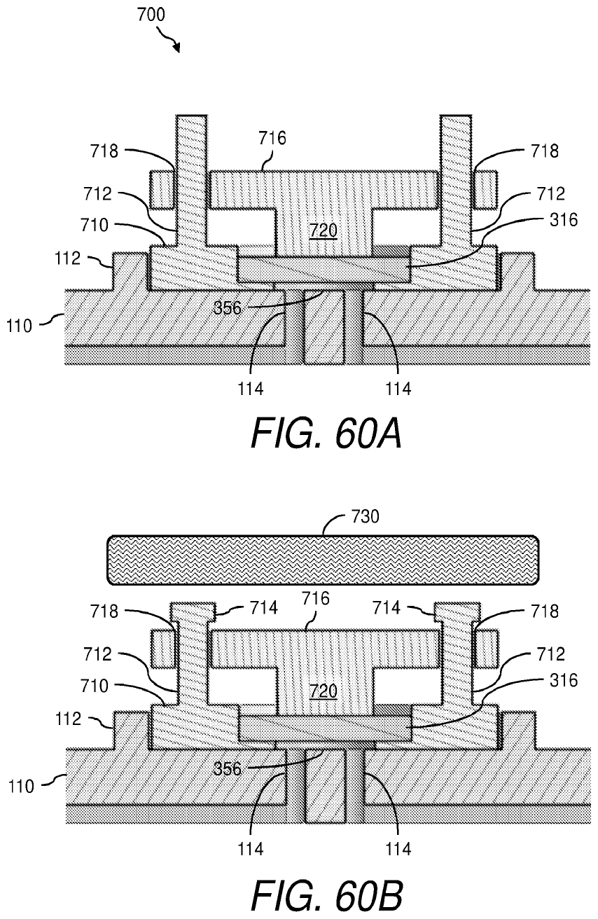

Referring now to FIG. 59 is a perspective view of a non-limiting example of a modular pinch valve 700 having a rivet weld design. For example, FIG. 59 shows modular pinch valve 700 installed in valve receptacle 112 of microfluidic device 110. Modular pinch valve 700 may include, for example, a valve body 710 having a pair of posts 712 directed upward away from microfluidic device 110. Modular pinch valve 700 may also include a top plate 716 having a pair of openings 718 and a pin portion 720. Further, flexible membrane 316 may be provided at the base of pin portion 720 for actuating modular pinch valve 700 (see FIG. 60A and FIG. 60B). In one non-limiting example, modular pinch valve 700 may be formed of rigid thermoplastic material whereas flexible membrane 316 may be formed of an elastomeric (flexible) material.

In modular pinch valve 700, top plate 716 may be arranged with respect to valve body 710 by fitting the posts 712 of the valve body 710 through the openings 718 of top plate 716 and then forming a rivet head 714 atop each post 712, as shown in FIG. 60A and FIG. 60B. For example, FIG. 60A and FIG. 60B show cross-sectional views of a non-limiting example of a process of forming rivet heads 714. FIG. 60A shows the first step of fitting the posts 712 of the valve body 710 through the openings 718 of top plate 716. FIG. 60B shows the next step of heating the ends of posts 712 to a melting point suitable to form a rivet head 714 atop each post 712. Any type of heat source 730 may be used to form rivet heads 714. This process may be possible because posts 712 are formed of a thermoplastic material that may be melted.

Overall, modular pinch valve 700 may be formed using the following steps. In a first step, the rigid valve body 710 with posts 712 may be formed using a thermoplastic injection molding process. Next, the flexible membrane 316 may be molded onto the surfaces of the rigid valve body 710. In this non-limiting example, a chemical bond may exist between valve body 710 and flexible membrane 316. Next, the top plate 716 with the pin portion 720 and openings 718 may be formed using a thermoplastic injection molding process. Then, the top plate 716 may be installed atop valve body 710 as described above. Further, once formed, modular pinch valve 700 may be mechanically coupled to valve receptacle 112 of microfluidic device 110. For example, the rigid valve body 710 may be welded into valve receptacle 112.

In operation, flexible membrane 316 may serve as the portion of modular pinch valve 700 that may be actuated via a valve actuator 190 pushing on pin portion 720 of the top plate. That is, flexible membrane 316 may be actuated in relation to space 356 and the two (2) fluid channels 114 of microfluidic device 110 to either allow flow or block flow. Generally, modular pinch valve 700 having the rivet weld design may be provided in the normally open state.

Following long-standing patent law convention, the terms “a,” “an,” and “the” refer to “one or more” when used in this application, including the claims. Thus, for examples, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present disclosure.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions, and uses of the invention will be apparent to the skilled person without departing from the scope and spirit of the invention. Although the invention has been disclosed in connection with specific preferred aspects or embodiments, it should be understood that the invention as claimed should not be unduly limited to such specific aspects or embodiments.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and non-limiting example for purposes of clarity of understanding, it will be understood by those skilled in the art that certain changes and modifications can be practiced within the scope of the appended claims.

The presently disclosed subject matter relates generally to methods of controlling flow within microfluidic devices and more particularly to modular microvalves for microfluidic devices and methods of using them.

1. A modular micro valve for use in a micro fluidic device comprising:
a. a valve supporter comprising:
i. a cylindrical non-compressible valve body having an inner surface, an outer surface, a top surface, a bottom surface, and an inner chamber; and
ii. at least one integrated snap-arm coupled to the valve body and configured to couple the valve to a receptacle;
b. a valve actuator seated within the valve supporter and comprising:
a compressible flex component comprising;
a pin; and
wherein the bottom surface of the valve supporter is in a sealable relationship with a corresponding top surface of the valve actuator; and
wherein the valve actuator is actuatable between a compressed and a non-compressed state.

2. The modular micro valve for use in a micro fluidic device according to claim 1, wherein each snap-arm extends outwards from a side of the top outer surface of the valve supporter, and wherein each snap-arm comprises a shoulder feature, an outer flat component extending downwards from the shoulder feature, and a latch-end at a proximal end of the outer flat component.

3. The modular micro valve for use in a micro fluidic device according to claim 1, wherein the pin is frustoconical in shape or wherein the pin is a tapered cylinder.

4. (canceled)

5. The modular micro valve for use in a micro fluidic device according to claim 1, wherein the pin further comprises a divot feature on a proximal end of the pin, wherein the divot feature comprises an actuatable flow space configured to either block fluid flow when compressed or to allow fluid flow when uncompressed.

6. An assembly comprising the modular microvalve of claim 1 coupled to a microfluidic device, where the microfluidic device comprises:
i. one or more valve receptacles protruding upward from a top surface of the microfluidic device and arranged to allow the modular microvalves to engagedly connect to the valve receptacles via the snap-arms;
ii. latch features corresponding to the snap-arms arranged for engaging the snap-arms and thereby sealing the modular micro valve into the valve receptacle;
iii. one or more fluid openings in fluid contact with corresponding fluid channels arranged to allow for fluid communication between the modular microvalves and the fluid channels; and
iv. one or more fluid input loading wells in fluid communication with the fluid channels.

7. The assembly of claim 6, wherein the latch features further comprise lip-edges in corresponding openings in the valve receptacles to engagedly connect to latch-ends.

8. The assembly of claim 6, wherein the modular microvalve is arranged such that compression of the valve actuator prevents liquid flow from the fluid input loading well into the corresponding fluid opening.

9. The assembly of claim 6, wherein the assembly comprises an array of modular microvalves and corresponding valve receptacles.

10. The assembly of claim 9, wherein the array of modular microvalves and corresponding valve receptacles are configured in a series, in parallel, or a combination thereof.

11. (canceled)

12. (canceled)

13. The assembly of claim 6, wherein the array comprises at least one modular microvalve and a corresponding valve receptacle.

14. The assembly of claim 6, wherein the array comprises a plurality of modular microvalves and corresponding valve receptacles.

15. (canceled)

16. The assembly of claim 6, wherein the microfluidic device further comprises an actuation means for applying a compression force to the modular microvalve.

17. The assembly of claim 16, wherein the actuation means for applying a compression force is selected from a group consisting of a solenoid and piston mechanism, a pneumatic mechanism, or other suitable means for applying a compression force to actuate the pin of the modular microvalve.

18. The assembly of claim 6, wherein the modular micro valves in fluid communication with the fluid channels are actuatable between a closed configuration that inhibits fluid flow through the fluid openings into the fluid channels when the pin is in a compressed state and an open configuration allowing fluid flow from the fluid input loading wells through the fluid openings into the fluid channels when the pin is in an uncompressed state.

19. The modular micro valve of claim 1, wherein the valve supporter comprises a thermoplastic material.

20. The modular micro valve of claim 19, wherein the thermoplastic material is selected from a group consisting of polycarbonate (PC), acrylonitrile butadiene styrene (ABS), or any other suitable rigid thermoplastic material.

21. The modular micro valve of claim 1, wherein the valve actuator comprises an elastomeric material.

22. The modular microvalve of claim 21, wherein the elastomeric material is selected from a group consisting of silicone, hydrogel, PDMS, TPE material, or any other suitable elastomeric material.

23. The modular micro valve of claim 1, wherein the diameter of the modular micro valve is from about 8 mm to about 15 mm.

24. The modular micro valve of claim 1, wherein the snap-arms extend outward from the valve supporter from about 1 mm to about 2 mm.

25. The modular micro valve of claim 1, wherein the height of the modular microvalve is from about 3.6 mm to about 7.6 mm.

26. (canceled)

27. A method of forming a modular micro valve for use in a micro fluidic device, comprising the steps of:
i. injection molding the valve supporter of claim 1; and
ii. injection molding the valve actuator of claim 1 onto the surface of the valve supporter.

28. A method of forming a modular micro valve for use in a micro fluidic device, comprising the steps of:
i. injection molding a separate valve supporter of claim 1;
ii. injection molding a separate valve actuator of claim 1; and
iii. adhering the separate valve supporter and the separate valve actuator together to form a single modular microvalve.

29.-43. (canceled)
